(19) United States
(12) Patent Application Publication
(10) Pub. No.: US 2014/0102526 A1
(43) Pub. Date: Apr. 17, 2014

(54) PHOTOELECTRIC CONVERSION DEVICE, METHOD FOR MANUFACTURING SAME, DYE ADSORPTION DEVICE, LIQUID RETAINING JIG USED FOR DYE ADSORPTION DEVICE, AND METHOD FOR MANUFACTURING PHOTOELECTRIC CONVERSION ELEMENT

(71) Applicants: Keisuke Matsuo, Kanagawa (JP); Akira Kogo, Kanagawa (JP); Tetsuya Komine, Kanagawa (JP); Setsuo Okino, Tokyo (JP)

(72) Inventors: Keisuke Matsuo, Kanagawa (JP); Akira Kogo, Kanagawa (JP); Tetsuya Komine, Kanagawa (JP); Setsuo Okino, Tokyo (JP)

(73) Assignee: Sony Corporation, Tokyo (JP)

(21) Appl. No.: 14/125,624

(22) PCT Filed: Jun. 15, 2012
(86) PCT No.: PCT/JP2012/065924

§ 371 Date: Dec. 12, 2013

(30) Foreign Application Priority Data
Jun. 24, 2011 (JP) 2011-141149
Jun. 24, 2011 (JP) 2011-141150

(51) Int. Cl. H01G 9/20

(52) U.S. Cl. CPC H01G 9/2077; H01G 9/2013
USPC 136/255; 438/64; 137/561 R

(57) ABSTRACT

Provided is a photoelectric conversion device which is capable of improving utilization efficiency of dye, a method for manufacturing the same, a dye adsorption device, a liquid retaining jig used for the dye adsorption device, and a method for manufacturing a photoelectric conversion element.

The photoelectric conversion device includes a conductive base material, a porous semiconductor layer which is disposed on the conductive base material and onto which dye is adsorbed, a counter electrode, an electrolyte layer, a sealing material that is formed at the periphery of the conductive base material, and at least one protrusion formed between the porous semiconductor layer and an outer periphery of the sealing material.

### TECHNICAL FIELD

The present technique relates to a photoelectric conversion device, a method for manufacturing the same, a dye adsorption device, a liquid retaining jig used for the dye adsorption device, and a method for manufacturing a photoelectric conversion element.

### BACKGROUND ART

A photoelectric conversion device such as a dye-sensitized solar cell (DSSC) has characteristics such as an electrolyte may be used, a raw material is inexpensive and the manufacturing cost is low, and decorativeness due to utilization of dye is present, and thus in recent years, the photoelectric conversion device has been actively studied. In general, the photoelectric conversion device includes a substrate in which a conductive layer is formed, a dye-sensitized semiconductor layer in which a semiconductor fine particle layer (TiO₂ layer and the like) and a dye are combined, a charge transporting agent such as iodine, and a counter electrode.

Generally, a layer, which is obtained by applying TiO₂ nanoparticles in a paste form on a conductive layer-attached substrate and by sintering it at approximately 450° C., is used as the semiconductor fine particle layer. The TiO₂ layer has a plurality of nano-sized pores, and a dye such as a ruthenium complex dye is adsorbed onto the inner surface of the pores. As a dye adsorption process, a dye adsorption process by a dipping method, a dropping method, and the like is used. For example, in Patent Document 1, a dye adsorption process by the dropping method is used.

### CITATION LIST

### Patent Document

Patent Document 1: JP 2005-347136 A

### SUMMARY OF THE INVENTION

### Problems to be Solved by the Invention

In recent years, development of the dye adsorption process to decrease an amount of a dye solution has been actively in progress.

An object of the present technique is to provide a photoelectric conversion device capable of improving utilization efficiency of dye, a method for manufacturing the same, a dye adsorption device, a liquid retaining jig used for the dye adsorption device, and a method for manufacturing a photoelectric conversion element.

### Solutions to Problems

In order to solve the above problem, the present technique provides a photoelectric conversion device, including: a conductive base material; a porous semiconductor layer which is disposed on the conductive base material and onto which dye is adsorbed; a counter electrode; an electrolyte layer; a sealing material that is formed at the periphery of the conductive base material; and at least one protrusion formed between the porous semiconductor layer and an outer periphery of the sealing material.

The present technique relates to a method for manufacturing a photoelectric conversion device. The method includes: forming a porous semiconductor layer on a conductive base material; forming at least one protrusion between with an outer periphery of a sealing material formed at the periphery of the conductive base material to surround the porous semiconductor layer; and bringing an elastic body into close contact with the protrusion to form a liquid retaining space that surrounds the porous semiconductor layer, retaining a dye solution in the liquid retaining space, and adsorbing a dye to the porous semiconductor layer.

In the technique, the liquid retaining space that surrounds the porous semiconductor layer is formed in a dye-adsorbed body by bringing an elastic body into contact with at least one protrusion between the porous semiconductor layer and the outer periphery of the sealing material. In addition, the dye solution is collected in the liquid retaining space to adsorb the dye to the porous semiconductor layer, and thus leakage of the dye solution from the liquid retaining space is suppressed. According to this, utilization efficiency of dye may be improved.

The present technique relates to a dye adsorption device, including: a dye solution supply unit; and a dye solution adsorption unit, wherein the dye solution adsorption unit includes a liquid retaining jig having a base body on which a photoelectrode base material for a photoelectric conversion element is mounted, and a cover body that forms a liquid retaining space on a surface of the photoelectrode base material, and the cover body has an elastic member that presses a peripheral portion of a dye adsorption region of the photoelectrode base material mounted on the base body.

The present technique relates to a liquid retaining jig. The liquid retaining jig includes: a base body on which a photoelectrode base material for a photoelectric conversion element is mounted; and a cover body that is disposed on a surface of the photoelectrode base material mounted on the base body and forms a liquid retaining space on a surface of a dye adsorption region of the photoelectrode base material. The cover body includes an elastic member that presses a peripheral portion of the dye adsorption region of the photoelectrode base material mounted on the base body.

The present technique relates to a method for manufacturing a photoelectric conversion element. The method includes: mounting a photoelectrode base material for a photoelectric conversion element on a base body; disposing a cover body, which presses a peripheral portion of a dye adsorption region of the photoelectrode base material, on a surface of the photoelectrode base material to form a liquid retaining space; and supplying a dye solution to the liquid retaining space to adsorb dye to the photoelectrode base material.

In the technique, the liquid retaining space is formed on the surface of the liquid adsorption region. The dye solution is supplied to the liquid retaining space. The dye solution is maintained in the liquid retaining space formed on the surface of the liquid adsorption region, and thus utilization efficiency of a dye may be improved.

### Effects of the Invention

According to the present technique, utilization efficiency of dye may be improved.

### BRIEF DESCRIPTION OF DRAWINGS

FIG. 1A is a cross-sectional view illustrating a configuration example of a photoelectric conversion device according to a first embodiment of the present technique. FIG. 1B is a cross-sectional view taken along a line B-B illustrated in FIG. 1A.

FIG. 2A is a plan view illustrating a configuration of a photoelectric conversion device in which a transparent conductive base material is omitted. FIG. 2B is a cross-sectional view taken along a line X-X illustrated in FIG. 2A. FIG. 2C is a cross-sectional view taken along a line Y-Y illustrated in FIG. 2A.

FIG. 3 is an enlarged plan view of a region R illustrated in FIG. 2A.

FIG. 4A is a cross-sectional view of a modification example of a structure. FIG. 4B is a cross-sectional view of a modification example of a structure.

FIG. 5A is a plan view illustrating a configuration example of a liquid retaining jig. FIG. 5B is a cross-sectional view illustrating the configuration example of the liquid retaining jig. FIG. 5C is a cross-sectional view illustrating the configuration example of the liquid retaining jig.

FIG. 6 is a cross-sectional view illustrating a state in which a dye solution is collected in a liquid retaining space of a liquid retaining jig to which a dye-adsorbed body is fixed.

FIG. 7A is a plan view illustrating a state in which the dye-adsorbed body is fixed to the liquid retaining jig. FIG. 7B is a cross-sectional view taken along a line Q-Q illustrated in FIG. 7A. FIG. 7C is a cross-sectional view illustrating an example of a close contact state of a packing in a case in which a structure is not provided. FIG. 7D is a cross-sectional view illustrating another example of the close contact state of the packing in a case in which a structure is not provided.

FIG. 8 is a schematic view illustrating the outlines of the dye adsorption device.

FIG. 9 is a schematic diagram illustrating a configuration example of a rack.

FIG. 10 is a flowchart of the dye adsorption device.

FIG. 11A is a plan view illustrating a configuration example of a pressing plate. FIG. 11B is a cross-sectional view of the pressing plate and a base plate.

FIG. 12A is a plan view illustrating a state in which the dye-adsorbed body is fixed to the liquid retaining jig. FIG. 12B is a cross-sectional view taken along a line Q-Q illustrated in FIG. 12A. FIG. 12C is a cross-sectional view taken along a line L illustrated in FIG. 12A.

FIG. 13A is a cross-sectional view illustrating a configuration example of the liquid retaining jig. FIG. 13B is a plan view illustrating a configuration example of the liquid retaining jig. FIG. 13C is a cross-sectional view illustrating a configuration example of the liquid retaining jig.

FIG. 14A is a plan view illustrating a configuration example of the liquid retaining jig. FIG. 14B is a plan view illustrating a configuration example of the liquid retaining jig.

FIG. 15 is a perspective view illustrating a configuration example of the liquid retaining jig.

FIG. 16A is a perspective view illustrating a configuration example of the liquid retaining jig. FIG. 16B is a perspective view illustrating a configuration example of the liquid retaining jig. FIG. 16C is an exploded perspective view of a case in which the liquid retaining jig to which the dye-adsorbed body is fixed is observed from an oblique upper side.

FIG. 17A is a cross-sectional view illustrating a configuration example of the liquid retaining jig. FIG. 17B is a cross-sectional view illustrating a configuration example of the liquid retaining jig. FIG. 17C is a perspective view illustrating a configuration example of the liquid retaining jig.

FIG. 18A is a cross-sectional view illustrating a first example of a method for fixing the pressing plate and the base plate. FIG. 18B is a cross-sectional view illustrating a second example of the method for fixing the pressing plate and the base plate. FIG. 18C is a cross-sectional view illustrating a third example of the method for fixing the pressing plate and the base plate. FIG. 18D is a cross-sectional view illustrating the third example of the method for fixing the pressing plate and the base plate. FIG. 18E is a cross-sectional view illustrating a fourth example of the method for fixing the pressing plate and the base plate.

FIG. 19A is a schematic diagram illustrating a first example of an injection method and a recovery method of a dye solution. FIG. 19B is a schematic diagram illustrating a second example of the injection method and the recovery method of the dye solution. FIG. 19C is a schematic diagram illustrating a modification example of the injection method of the dye solution.

FIG. 20A is a schematic diagram illustrating the recovery method of the dye solution. FIG. 20B is a schematic diagram illustrating the recovery method of the dye solution.

FIG. 21A is a schematic diagram illustrating a configuration example of the rack. FIG. 21B is a schematic diagram illustrating the recovery method of the dye solution.

FIG. 22 is a schematic diagram illustrating a configuration example of a dye solution recovery tank.

FIG. 23 is a schematic diagram illustrating an injection method of a rinse liquid.

FIG. 24 is a schematic diagram illustrating a configuration example of a rinse liquid injection position, a rinse liquid recovery position, and a dry position.

FIG. 25A is a plan view illustrating a configuration example of a photoelectric conversion device in which a transparent conductive base material is omitted. FIG. 25B is a cross-sectional view taken along a line X-X illustrated in FIG. 25A. FIG. 25C is a cross-sectional view taken along a line Y-Y illustrated in FIG. 25A. FIG. 25D is a cross-sectional view taken along a line Z-Z illustrated in FIG. 25A.

FIG. 26 is an enlarged plan view of a region R illustrated in FIG. 25A.

FIG. 27A is a cross-sectional view illustrating a configuration example and an arrangement example of the packing.

FIG. 27B is a cross-sectional view illustrating a configuration example and an arrangement example of the packing. FIG. 27C is a cross-sectional view illustrating a configuration example and an arrangement example of the packing.

FIG. 28A is a plan view illustrating a configuration example of a photoelectric conversion device in which a transparent conductive base material is omitted. FIG. 28B is a cross-sectional view taken along a line X-X illustrated in FIG. 28A. FIG. 28C is a cross-sectional view taken along a line Y-Y illustrated in FIG. 28A. FIG. 28D is a cross-sectional view taken along a line Z-Z illustrated in FIG. 28A.

FIG. 29 is an enlarged plan view of a region R illustrated in FIG. 28A.

FIG. 30 is a cross-sectional view illustrating a configuration example and an arrangement example of the packing.

FIG. 31 is a plan view illustrating an effect of an opaque structure.

FIG. 32A is a plan view illustrating a configuration example of a photoelectric conversion device in which a transparent conductive base material is omitted. FIG. 32B is a cross-sectional view taken along a line L illustrated in FIG. 32A.

FIG. 33 is an enlarged plan view of a region R illustrated in FIG. 32A.

FIG. 34 is a cross-sectional view illustrating a configuration example and an arrangement example of the packing.

FIG. 35A is a plan view illustrating a configuration example of a photoelectric conversion device in which a transparent conductive base material is omitted. FIG. 35B is a cross-sectional view taken along a line L illustrated in FIG. 35A.

FIG. 36 is an enlarged plan view of a region R illustrated in FIG. 35A.

FIG. 37 is a cross-sectional view illustrating a configuration example and an arrangement example of the packing.

FIG. 38A is a plan view illustrating a configuration example of a photoelectric conversion device in which a transparent conductive base material is omitted. FIG. 38B is a cross-sectional view taken along a line L illustrated in FIG. 38A.

FIG. 39 is an enlarged plan view of a region R illustrated in FIG. 38A.

FIG. 40 is a cross-sectional view illustrating a configuration example and an arrangement example of the packing.

FIG. 41A is a plan view illustrating a configuration example of a photoelectric conversion device in which a transparent conductive base material is omitted. FIG. 41B is a cross-sectional view taken along a line L illustrated in FIG. 41A.

FIG. 42 is an enlarged plan view of a region R illustrated in FIG. 41A.

FIG. 43 is a cross-sectional view illustrating a configuration example and an arrangement example of the packing.

FIG. 44 is a plan view illustrating a configuration example of a dye-adsorbed body prepared in Examples and Comparative Examples.

FIG. 45 is a graph illustrating measurement results of Example 1 and Comparative Example 1.

FIG. 46 is a graph illustrating the measurement results of Example 1 and Comparative Example 1.

FIG. 47 is a graph illustrating measurement results of Example 2-1, Example 2-2, and Comparative Example 2.

### MODE FOR CARRYING OUT THE INVENTION

Hereinafter, embodiments of the present technique will be described with reference to the attached drawings. Description will be given in the following order. In addition, in all of the drawings of the embodiments, the same reference numerals are given to the same or corresponding portions.

1. First Embodiment

(An example of a photoelectric conversion device provided with a structure embedded in a concave portion between a plurality of current collector portions)

2. Second Embodiment

(An example of a photoelectric conversion device provided with an inner structure and an outer structure which are embedded in the concave portion between the plurality of current collector portions)

3. Third Embodiment

(An example of a photoelectric conversion device provided with an inner structure, an outer structure, and an opaque structure which are embedded in the concave portion between the plurality of current collector portions)

4. Fourth Embodiment

(Another example of the photoelectric conversion device provided with the structure that is embedded in the concave portion between the plurality of current collector portions)

5. Fifth Embodiment

(Still another example of the photoelectric conversion device provided with an inner structure and an outer structure which are embedded in the concave portion between the plurality of current collector portions)

6. Sixth Embodiment

(Another first example of the photoelectric conversion device provided with the inner structure, the outer structure, and the opaque structure which are embedded in the concave portion between the plurality of current collector portions)

7. Seventh Embodiment

(Another second example of the photoelectric conversion device provided with the inner structure, the outer structure, and the opaque structure which are embedded in the concave portion between the plurality of current collector portions)

8. Another Embodiment (Modification Example)

### 1. FIRST EMBODIMENT

### Configuration of Photoelectric Conversion Device

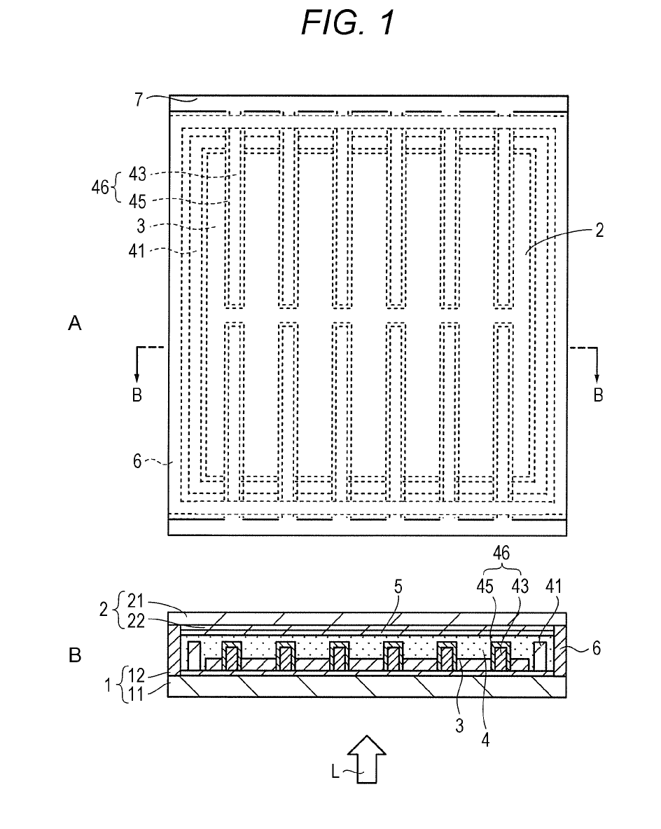

A configuration example of a photoelectric conversion device according to the first embodiment of the present technique will be described. FIG. 1A shows a cross-sectional view illustrating a configuration example of the photoelectric conversion device according to the first embodiment of the present technique. FIG. 1B illustrates a cross-sectional view taken along a line B-B illustrated in FIG. 1A. As illustrated in FIGS. 1A and 1B, the photoelectric conversion device includes a transparent conductive base material 1, a transparent conductive base material 2, a porous semiconductor layer 3 on which dye is carried, an electrolyte layer 4, a counter electrode 5, a sealing material 6, a structure 41, a current collector portion 46, and a current collector terminal 7.

The transparent conductive base material 1 and the transparent conductive base material 2 are disposed to be opposite to each other. The transparent conductive base material 1 has one main surface that is opposite to the transparent conductive base material 2, and the porous semiconductor layer 3 is formed on this one main surface. The transparent conductive base material 2 has one main surface that is opposite to the transparent conductive base material 1, and the counter electrode 5 is formed on this one main surface. The electrolyte layer 4 is interposed between the porous semiconductor layer 3 and the counter electrode 5 which are opposite to each other. The transparent conductive base material 1 has the other main surface on a side opposite to the one main surface on which the porous semiconductor layer 3 is formed, and for example, the other main surface serves as a light receiving surface that receives light L such as solar light.

The sealing material 6 is provided at the peripheral portion of the opposed surfaces of the transparent conductive base material 1 and the transparent conductive base material 2. The distance between the porous semiconductor layer 3 and the counter electrode 5 is preferably 1 μm to 100 μm, and more preferably 1 μm to 40 μm. The electrolyte layer 4 is sealed in a space surrounded by the transparent conductive base material 1 on which the porous semiconductor layer 3 is formed, the transparent conductive base material 2 on which the counter electrode 5 is formed, and the sealing material 6.

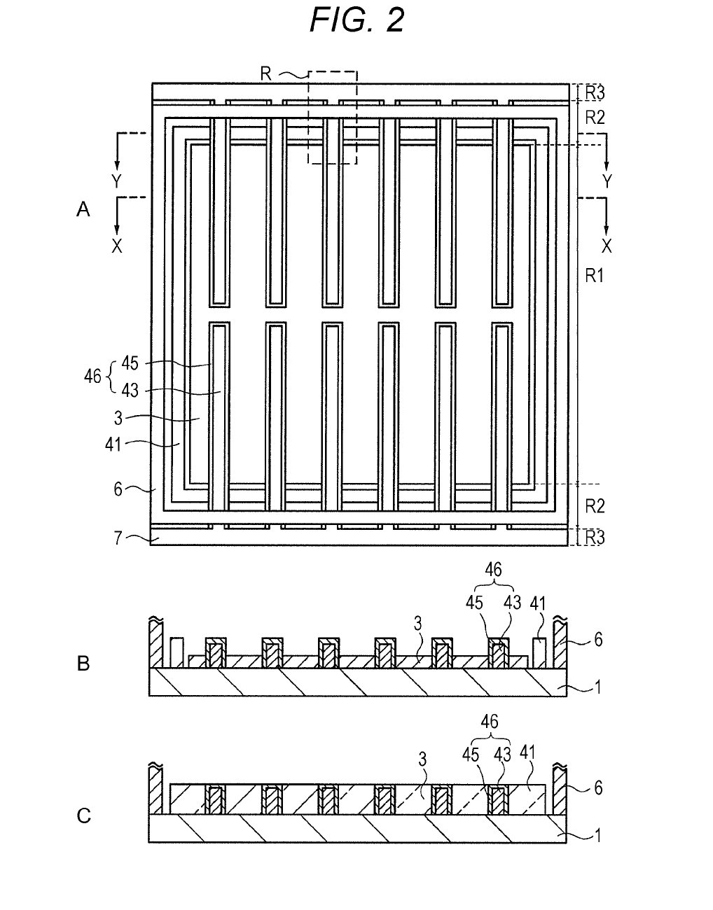

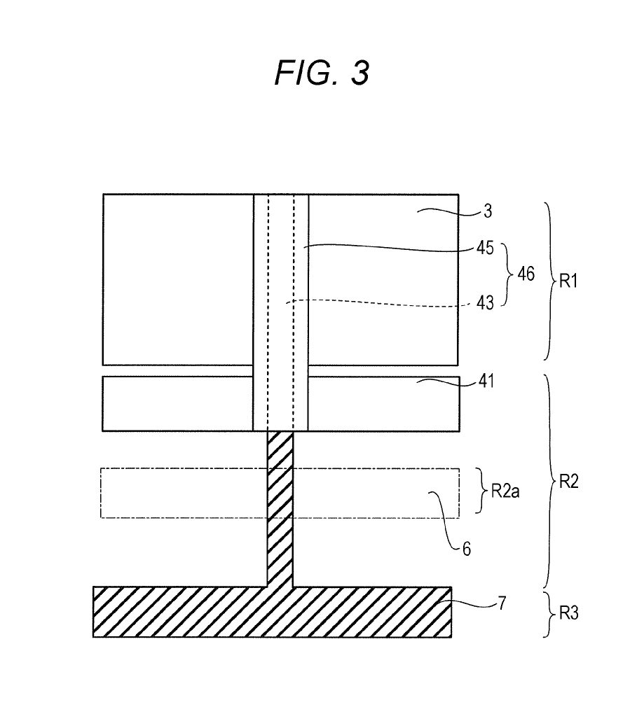

FIG. 2A illustrates a plan view in which the transparent conductive base material is omitted. FIG. 2B illustrates a cross-sectional view taken along a line X-X illustrated in FIG. 2A. FIG. 2c illustrates a cross-sectional view taken along a line Y-Y illustrated in FIG. 2A. FIG. 3 illustrates an enlarged plan view of a region R illustrated in FIG. 2A.

As illustrated in FIG. 2A and FIG. 3, a region R1 in which the porous semiconductor layer 3 onto which dye is adsorbed is formed, a region R3 in which the current collector terminal 7 is formed, and a region R2 between the region R1 and the region R3 are set on the transparent conductive base material 1. In the region R2, the structure 41 is formed at an inner side of a region R2a in which the sealing material 6 is formed.

As illustrated in FIG. 2B, in the region R1, a plurality of stripe-shaped current collectors 43, which are current collector wires and which are divided into parts at the center, are formed in a region in which the porous semiconductor layer 3 onto which dye is adsorbed is not formed. The plurality of stripe-shaped current collector portions 46 that are divided into parts at the center are constituted by a current collector 43 and a protective layer 45 which covers a surface of the current collector 43.

The plurality of stripe-shaped current collectors 43, which are divided into parts at the center, may be classified into current collectors on an upper-side side of the periphery and current collectors on a lower-side side of the periphery. The plurality of current collectors 43 on the upper-side side of the periphery extend toward the upper side of the periphery from the center and are arranged in parallel with each other in a row. A comb-like shape is formed by the plurality of current collectors 43 that are connected to the strip-shaped current collector terminal 7 provided along the upper side of the periphery, and the strip-shaped current collector terminal 7. The current collectors 43 on the lower-side side of the periphery extend toward the lower side of the periphery from the center and are arranged in parallel with each other in a row. A comb-like shape is formed by the plurality of current collectors 43 that are connected to the strip-shaped current collector terminal 7 provided along the lower side of the periphery, and the strip-shaped current collector terminal 7.

As illustrated in FIG. 2C, in the region R2 between the region R1 and the region R3, the structure 41 having the same height as the current collector portions 46 is embedded in a concave portion between the plurality of current collector portions 46 arranged in parallel. According to this, in the region R2 between the region R1 and the region R3, a protrusion having a flat surface at the top portion is formed by parts of the plurality of current collector portions that are arranged in parallel and the structure 41 embedded between the parts of the plurality of current collector portions that are arranged in parallel. Further, the structure 41 is provided along each of a right side and a left side of the periphery at an outer side of the porous semiconductor layer 3 onto which dye is adsorbed. A rectangular frame-shaped protrusion having a flat surface at the top portion is formed by the plurality of current collector portions 46 arranged in parallel, the structure 41 embedded in the concave portion between the plurality of current collector portions arranged in parallel, and the structure 41 provided along each of the right side and the left side of the periphery. The rectangular frame-shaped protrusion is provided to surround the porous semiconductor layer 3 onto which dye is adsorbed.

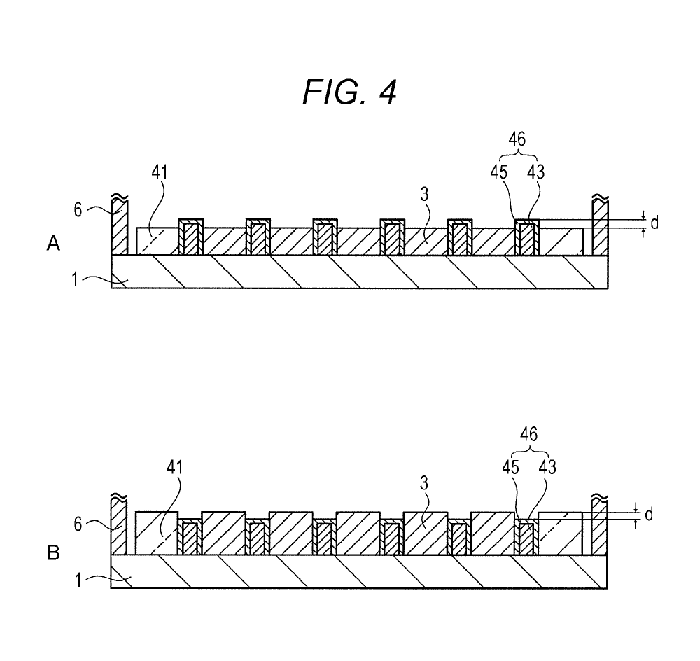

In addition, the configuration example of the structure 41 illustrated in FIGS. 2A to 2C and FIG. 3 has the same height as the current collector portions 46, but the configuration example of the structure 41 is not limited thereto. For example, the height of the structure 41 may be substantially the same as the height of the current collector portions 46. In addition, for example, as illustrated in FIG. 4A, the structure 41 may be lower than the height of the current collector portions 46 based on the transparent conductive base material 1. As illustrated in FIG. 4B, the structure 41 may be higher than the height of the current collector portions 46 based on the transparent conductive base material 1. In this case, for example, a difference d in the height between the structure 41 and the current collector portions 46 is preferably 100 μm or less. The reason of this limitation is as follows. If the difference is 100 μm or less, when forming a liquid retaining space in a following dye adsorption process to be described later, unevenness of the protrusion may be absorbed at the side of a packing to be brought into close contact with the protrusion, and thus satisfactory adhesiveness with the packing may be maintained.

Hereinafter, the transparent conductive base materials 1 and 2, the porous semiconductor layer 3, a sensitizing dye, the counter electrode 5, the electrolyte layer 4, the structure 41, the sealing material 6, and the current collector 43 which constitute the photoelectric conversion device will be sequentially described.

(Transparent Conductive Base Material)

The transparent conductive base material 1 includes abase material 11 and a transparent conductive layer 12 formed on one main surface of the base material 11, and the porous semiconductor layer 3 is formed on the transparent conductive layer 12. The transparent conductive base material 2 includes a base material 21 and a transparent conductive layer 22 formed on one main surface of the base material 21, and the counter electrode 5 is formed on the transparent conductive layer 22.

As the base materials 11 and 21, various base materials may be used as long as the base materials have transparency. As a base material having transparency, a base material in which light absorption with respect to a visible region to a near infrared region of solar light is small is preferable. For example, a glass base material, a resin base material, and the like may be used, but the base material is not limited thereto. As a material of the glass base material, for example, quartz, a blue-board, BK7, lead glass, and the like may be used, but the material is not limited thereto. As the resin base material, for example, polyethylene terephthalate (PET), polyethylene naphthalate (PEN), polyimide (PI), polyester, polyethylene (PE), polycarbonate (PC), polyvinyl butyrate, polypropylene (PP), tetraacetyl cellulose, syndiotactic polystyrene, polyphenylene sulfide, polyarylate, polysulfone, polyester sulfone, polyether imide, cyclic polyolefin, brominated phenoxy, vinyl chloride, and the like may be used, but the base material is not limited thereto. As the base materials 11 and 12, for example, a film, a sheet, a substrate, and the like may be used, but there is no limitation thereto.

In addition, the base material 21 is not particularly limited to a base material having transparency, and an opaque base material may be used. For example, various base materials such as an inorganic base material and a plastic base material which have opacity may be used. In addition, an opaque base material such as a metal base material including a SUS base material may also be used.

The transparent conductive layers 12 and 22 are preferably small in light absorption with respect to a visible region to a near infrared region of solar light. As a material of the transparent conductive layers 12 and 22, for example, it is preferable to use a metal oxide and carbon which have satisfactory conductivity. As the metal oxide, for example, at least one kind of oxide selected from a group consisting of indium-tin composite oxide (ITO), fluorine-doped SnO₂ (FTO), antimony-doped SnO₂ (ATO), tin oxide (SnO₂), zinc oxide (ZnO), indium-zinc composite oxide (IZO), aluminum-zinc composite oxide (AZO), and gallium-zinc composite oxide (GZO) may be used. A layer for promotion of binding, improvement of electron transport, prevention of inverse electron process, and the like may be further provided between the transparent conductive layer 22 and the porous semiconductor layer 3.

(Porous Semiconductor Layer)

It is preferable that the porous semiconductor layer 3 be a porous layer containing metal oxide semiconductor fine particles. It is preferable that the metal oxide semiconductor fine particles contain metal oxides containing at least one kind of element selected from titanium, zinc, tin, and niobium. When the metal oxide is contained, an appropriate energy band is formed between an adsorption dye and a metal oxide. Accordingly, electrons generated from the dye by light irradiation are smoothly transmitted to the metal oxide, and may contribute to power generation by oxidation and reduction of iodine. Specifically, as a material of the metal oxide semiconductor fine particles, one or more kinds of oxides selected from a group consisting of titanium oxide, tin oxide, tungsten oxide, zinc oxide, indium oxide, niobium oxide, iron oxide, nickel oxide, cobalt oxide, strontium oxide, tantalum oxide, antimony oxide, lanthanoide oxides, yttrium oxide, vanadium oxide, and the like may be used, but the material is not limited thereto. It is preferable that a conduction band of the porous semiconductor layer 3 be located at a position capable of easily receiving electrodes from a photoexcited orbital of the sensitizing dye in order for a surface of the porous semiconductor layer to be sensitized by a sensitizing dye. From this viewpoint, among the above-described materials of the metal oxide semiconductor particles, one or more kinds of materials selected from a group consisting of titanium oxide, zinc oxide, tin oxide, and niobium oxide are more preferable. Furthermore, titanium oxide is still more preferable from the viewpoints of price, environmental sanitation, and the like. Particularly, it is preferable that the metal oxide semiconductor fine particles contain titanium oxide having an anatase type or brookite type crystal structure. The reason of this is because when the titanium oxide is contained, an appropriate energy band is formed between an adsorption dye and a metal oxide, and electrons generated from the dye due to light irradiation are smoothly transmitted to the metal oxide and may contribute to power generation by oxidation and reduction of iodine. An average primary particle size of the metal oxide semiconductor fine particles is preferably 5 nm to 500 nm. When the average primary particle size is less than 5 nm, crystallinity significantly deteriorates, and thus there is a tendency that an amorphous structure is formed and the anatase structure cannot be maintained. On the other hand, when the average primary particle size exceeds 500 nm, a specific surface area significantly decreases, and thus there is a tendency that the total amount of dye which is adsorbed onto the porous semiconductor layer 3 and contributes to the power generation decreases. Here, the average primary particle size is a value obtained by a measurement method by a light scattering method using a primary-particle-dispersed diluted solution which is obtained by using a solvent system capable of dispersing primary particles, and adding a desired dispersant.

(Sensitizing Dye)

A sensitizing dye for photoelectric conversion is not particularly limited as long as a sensitizing action is exhibited, but commonly, a material capable of absorbing light in the vicinity of visible light region is used. For example, bipyridine complex, terpyridine complex, merocyanine dyes, porphyrin, phthalocyanine, and the like are used.

As a sensitizing dye that is used alone, for example, cis-bis(isothiocyanate)bis(2,2′-bipyridyl-4,4′-dicarboxylic acid) ruthenium (II)2 tetrabutylammonium complex (common name: N719), which is a kind of bipyridine complex, has an excellent performance as a sensitizing dye and thus is generally used. In addition to this, cis-bis(isothiocyanate)bis(2,2′-bipyridyl-4,4′-dicarboxylic acid) ruthenium (II) (common name: N3) which is a kind of bipyridine complex, or tris(isothiocyanate) (2,2′: 6′,2″-terpyridyl-4,4′,4″-tricarboxylic acid) ruthenium (II)3 tetrabutylammonium complex (common name: black dye) which is a kind of terpyridine complex is generally used.

Particularly, in a case of using the N3 or black dye, coadsorbent is frequently used. The coadsorbent is a molecule that is added to prevent mutual association of dye molecules on the porous semiconductor layer 3. As a representative coabsorbent, for example, chenodeoxycholic acid, taurodeoxycholate, 1-decrylphosphonic acid, and the like may be exemplified. As structural characteristics of the molecules, the following characteristics and the like may be exemplified. The molecules have a carboxyl group, a phosphono group, or the like as a functional group which is easily adsorbed to titanium oxide that constitutes the porous semiconductor layer 3. The molecules are interposed between dye molecules and are formed by σ bond to prevent interference between dye molecules.

Examples of other sensitizing dyes include azo-based dyes, quinacridone-based dyes, diketopyrrolopyrrole-based dyes, squarylium-based dyes, cyanine-based dyes, merocyanine-based dyes, triphenylmethane-based dyes, xanthene-based dyes, porphine-based dyes, chlorophyll-based dyes, ruthenium complex-based dyes, indigo-based dyes, perylene-based dyes, oxazine-based dyes, anthraquinone-based dyes, phthalocyanine-based dyes, naphthalocyanine-based dye, derivatives thereof, and the like, but there is no limitation thereto as long as a sensitizing dye is capable of absorbing light and of implanting excited electrons to the conduction band of the porous semiconductor layer 3. Preferably, the sensitizing dyes have one or more coupling groups in a structure thereof. In this case, the sensitizing dyes may be coupled to a surface of the porous semiconductor layer, and thus excited electrons of the photoexcited sensitizing dyes may be quickly transmitted to the conduction band of the porous semiconductor layer 3.

The film thickness of the porous semiconductor layer 3 is preferably 0.5 μm to 200 μm. When the film thickness is less than 0.5 μm, there is a tendency that effective conversion efficiency may not be obtained. On the other hand, when the film thickness exceeds 200 μm, cracking or peeling off tends to occur during film formation, and thus there is a tendency that production becomes difficult. In addition, a distance between a surface of the porous semiconductor layer 3 on an electrolyte layer side and a surface of the transparent conductive layer 12 on a porous semiconductor layer side increases, and thus charges that are generated are not effectively transmitted to the transparent conductive layer 12. Therefore, there is a tendency that it is difficult to obtain satisfactory conversion efficiency.

(Counter Electrode)

The counter electrode 5 functions as a positive electrode of a photoelectric conversion device (photoelectric conversion cell). As a conductive material that is used for the counter electrode 5, for example, a metal, a metal oxide, carbon, and the like may be exemplified, but the conductive material is not limited thereto. As the metal, for example, platinum, gold, silver, copper, aluminum, rhodium, indium, and the like may be used, but there is no limitation thereto. As the metal oxide, for example, ITO (indium-tin oxide), tin oxide (including tin oxide doped with fluorine or the like), zinc oxide, and the like may be used, but there is no limitation thereto. The film thickness of the counter electrode 5 is not particularly limited, but 5 nm to 100 μm is preferable.

(Electrolyte Layer)

It is preferable that the electrolyte layer 4 be constituted by an electrolyte, a medium, and an additive. As the electrolyte, a mixture of I₂ and an iodide (for example, LiI, NaI, KI, CsI, MgI₂, CaI₂, CuI, tetraalkyl ammonium iodide, pyridinium iodide, imidazolium iodide, and the like), and a mixture of Br₂ and bromide (for example, LiBr and the like) may be exemplified. Among these, an electrolyte in which as a combination of I₂ and the iodide, LiI, pyridinium iodide, imidazolium iodide, and the like are mixed is preferable, but there is no limitation to the combination.

The concentration of the electrolyte with respect to the medium is preferably 0.05 M to 10 M, more preferably 0.05 M to 5 M, still more preferably 0.2 M to 3 M. The concentration of I₂ or Br₂ is preferably 0.0005 M to 1 M, more preferably 0.001 M to 0.5 M, and still more preferably 0.001 M to 0.3 M. In addition, various additives such as 4-tert-butyl pyridine and benzimidazolium may be added to improve an open circuit voltage of the photoelectric conversion device.

As the medium that is used for the electrolyte layer 4, a compound capable of exhibiting satisfactory ion conductivity is preferable. Examples of a solution medium that may be used include ether compounds such as dioxane and diethyl ether, chain ethers such as ethylene glycol dialkyl ether, propylene glycol dialkyl ether, polyethylene glycol dialkyl ether, and polypropylene glycol dialkyl ether, alcohols such as methanol, ethanol, ethylene glycol monoalkyl ether, propylene glycol monoalkyl ether, polyethylene glycol monoalkyl ether, and polypropylene glycol monoalkyl ether, polyhydric alcohols such as ethylene glycol, propylene glycol, polyethylene glycol, polypropylene glycol, and glycerin, nitrile compounds such as acetonitrile, glutarodinitrile, methoxy acetonitrile, propionitrile, and benzonitrile, carbonate compounds such as ethylene carbonate and propylene carbonate, heterocyclic compounds such as 3-methyl-2-oxazolidinone, aprotic polar materials such as dimethyl sulfoxide and sulfolane, and the like.

In addition, a polymer may be contained in order to use a solid-state (including a gel-state) medium. In this case, a polymer such as polyacrylonitrile and polyvinylidene fluoride is added to the solution medium to polymerize a multifunctional monomer having an ethylenic unsaturated group in the solution medium, thereby converting the medium into a solid state.

In addition to these, electrolyte in which a CuI medium and a CuSCN medium are not necessary, and a hole transport material such as 2,2′,7,7′-tetrakis(N,N-di-p-methoxyphenyl amine)9,9′-spirobifluorene may be used as the electrolyte layer 4.

(Current Collector and Current Collector Terminal)

The current collector 43 and the current collector terminal 7 are formed from a material having electrical resistance lower than that of the transparent conductive layer. Examples of the material that constitutes the current collector 43 and the current collector terminal 7 include gold (Au), silver (Ag), aluminum (Al), copper (Cu), platinum (Pt), titanium (Ti), nickel (Ni), iron (Fe), zinc (Zn), molybdenum (Mo), tungsten (W), chromium (Cr), compounds and alloys of these metals, solder, and the like. In addition, it is preferable that the current collector 43 and the current collector terminal 7 be formed by applying conductive paste obtained from the materials by using a screen printing method, a dispenser, or the like. The entirety or a part of the current collector 43 may be formed from a conductive adhesive, a conductive rubber, anisotropic conductive adhesive, or the like as necessary.

(Protective Layer)

The protective layer 45 may be constituted by a material having corrosion resistance against an electrolyte (for example, iodine) that constitutes an electrolytic solution, and when the protective layer 45 is provided, the current collector 43 does not come into contact with the electrolyte layer 4, and thus an inverse electron migration reaction or corrosion of the current collector can be prevented. Examples of a material that constitutes the protective layer 45 include metal oxides, metal nitrides of TiN, WN, and the like, glass such as low melting point glass frit, and various resins such as epoxy resin, a silicone resin, a polyimide resin, an acrylic resin, a polyisobutylene resin, an ionomer resin, and a polyolefin resin.

(Sealing Material)

As a material of the sealing material 6, for example, a thermoplastic resin, a photocurable resin, glass frit, and the like may be used, but the material is not limited thereto.

(Structure)

The structure 41 is provided between the porous semiconductor layer 3 onto which dye is adsorbed, and the outer periphery of the sealing material 6. The structure 41 may be configured by one layer or two or more layers. For example, a layer that constitutes the structure 41 may be the same as at least any one of the current collector 43, the porous semiconductor layer 3, and the protective layer 45. As a material of the layer that constitutes the structure 41, the same material as at least anyone of the material of the current collector 43, the material of the porous semiconductor layer 3, and the material of the protective layer 45 may be used. From the viewpoint of cost, it is preferable to use the material of the porous semiconductor layer 3 in relation to the material of the current collector 43.

[Method for Manufacturing Photoelectric Conversion Device]

Next, an example of a method for manufacturing a photoelectric conversion device according to the first embodiment of the technique will be described.

(Formation of Transparent Conductive Base Material)

First, a sheet-shaped or film-shaped base material 11 is prepared. Next, the transparent conductive layer 12 is formed on the base material 11 by a thin film forming technology such as a sputtering method. According to this, the transparent conductive base material 1 may be obtained.

(Formation of Current Collector)

Next, the current collector 43 that is formed from, for example, silver is formed on the transparent conductive layer. For example, the current collector 43 is formed in a shape illustrated in FIG. 2A by making a material of the current collector 43 in a paste-like material and by applying the paste-like material using a screen printing method or the like. Then, drying and baking are carried out as necessary. In a case where the structure 41 includes the current collector 43, the current collector 43 as the structure 41 may be formed in a shape illustrated in FIG. 2A simultaneously with the formation of the current collector 43.

(Formation of Protective Layer)

Next, the protective layer 45 is formed on a surface of the current collector 43 to protect the current collector 43 by blocking the current collector 43 from the electrolytic solution. According to this, the current collector portion 46 is formed. Specifically, for example, the protective layer 45 is formed on the surface of the current collector 43 by applying an epoxy-based resin or the like for forming the protective layer 45 using a screen printing method or the like. For example, in the case of using the epoxy-based resin, after reveling of the epoxy-based resin is sufficiently carried out, the epoxy-based resin is completely cured by using an UV spot irradiation device. In a case where the structure 41 includes the protective layer 45, the protective layer 45 as the structure 41 may be formed in a shape illustrated in FIG. 2A simultaneously with formation of the protective layer 45.

(Formation of Porous Semiconductor Layer)

Next, the porous semiconductor layer 3 is formed on the transparent conductive layer 12 of the transparent conductive base material 1. Details of a process of forming the porous semiconductor layer 3 will be described.

First, metal oxide semiconductor fine particles are dispersed in a solvent to prepare paste that is a composition for forming the porous semiconductor layer. A binding agent (binder) may be further dispersed in the solvent as necessary. During preparation of the paste, mono-dispersed colloid particles that are obtained by hydrothermal synthesis may be used as necessary. As the solvent, for example, lower alcohol having 4 or less carbon atoms such as methanol, ethanol, isopropanol, n-butanol, sec-butanol, and t-butanol, aliphatic glycol such as ethylene glycol, propylene glycol (1,3-propanediol), 1,3-propanediol, 1,4-butanediol, 1,2-butanediol, 1,3-butanediol, and 2-methyl-1,3-propanediol, ketones such as methyl ethyl ketone, amines such as dimethyl ethyl amine, and the like may be used alone, or two or more kinds thereof may be mixed and used, but the solvent is not particularly limited thereto. As a dispersion method, specifically, for example, a known method may be used, and for example, stirring treatment, ultrasonic dispersion treatment, beads dispersion treatment, kneading treatment, homogenizer treatment, and the like may be used, but the dispersion method is not particularly limited thereto.

Next, a dispersed solution that is prepared is applied or printed on the transparent conductive layer 12, and then drying is carried out to volatilize the solvent. According to this, the porous semiconductor layer 3 is formed on the transparent conductive layer 12 in a shape illustrated in FIG. 2A. Drying conditions are not particularly limited, and natural drying may be carried out, or artificial drying may be carried out by adjusting a drying temperature, a drying time, and the like. In a case of the artificial drying, it is preferable to set the drying temperature and the drying time in a range not modifying the base material 11 in consideration of heat resistance of the base material 11. As an application method or a printing method, an appropriate method, which is convenient and is suitable for mass production, is preferably used. As the application method, for example, a micro gravure coating method, a wire bar coating method, a direct gravure coating method, a die coating method, a dipping method, a spray coating method, a reverse roll coating method, a curtain coating method, a comma coating method, a knife coating method, a spin coating method, and the like may be used, but the application method is not particularly limited thereto. In addition, as the printing method, for example, a relief printing method, an offset printing method, a gravure printing method, an intaglio printing method, a rubber plate printing method, a screen printing method, and the like may be used, but the printing method is not particularly limited thereto.

In a case where the structure 41 includes the porous semiconductor layer 3, simultaneously with formation of the porous semiconductor layer 3, the porous semiconductor layer 3 as the structure 41 may be formed in a shape illustrated in FIG. 2A in the same manner as the formation of the porous semiconductor layer 3.

(Baking)

Next, the porous semiconductor layer 3 that has been prepared as described above is baked to improve electronic connection between the metal oxide semiconductor fine particles in the porous semiconductor layer 3. A baking temperature is preferably 40° C. to 1000° C., and more preferably approximately 40° C. to 600° C., but the baking temperature is not particularly limited to the temperature. In addition, a baking time is preferably approximately 30 seconds to 10 hours, but the baking time is not particularly limited to this time range.

(Dye Carrying)

Next, a sensitizing dye is dissolved in a solvent to prepare a solution. Heating, addition of dissolution auxiliary agent, and filtration of an insoluble matter may be carried out to dissolve the sensitizing dye as necessary. As the solvent, a solvent which is capable of dissolving the sensitizing dye and capable of carrying out mediation of dye adsorption with respect to the porous semiconductor layer 3 is preferable, and for example, alcohol-based solvents such as ethanol, isopropyl alcohol, and benzyl alcohol, nitrile-based solvents such as acetonitrile and propionitrile, halogen-based solvents such as chloroform, dichloromethane, and chlorobenzene, ether-based solvents such as diethyl ether and tetrahydrofuran, ester-based solvents such as ethyl acetate, butyl acetate, ketone-based solvents such as acetone, methyl ethyl ketone, and cyclohexanone, carbonic acid ester based solvents such as diethyl carbonate and propylene carbonate, hydrocarbon-based solvents such as hexane, octane, toluene, and xylene, dimethyl formamide, dimethyl acetamide, dimethyl sulfoxide, 1,3-dimethyl-imidazolinone, N-methyl pyrrolidone, water, and the like may be used alone, or two or more kinds of these may be mixed and used, but the solvent is not particularly limited thereto.

Next, for example, with regard to the porous semiconductor layer 3, the sensitizing dye is carried on the metal oxide fine particles. At this time, the sensitizing dye may be carried on the metal oxide fine particles by a liquid retaining method in which a dye solution is collected in a liquid retaining space formed on a surface of the porous semiconductor layer 3 to adsorb the dye onto the porous semiconductor layer 3. The method is carried out by using a liquid retaining jig to be described later.

(Liquid Retaining Jig)

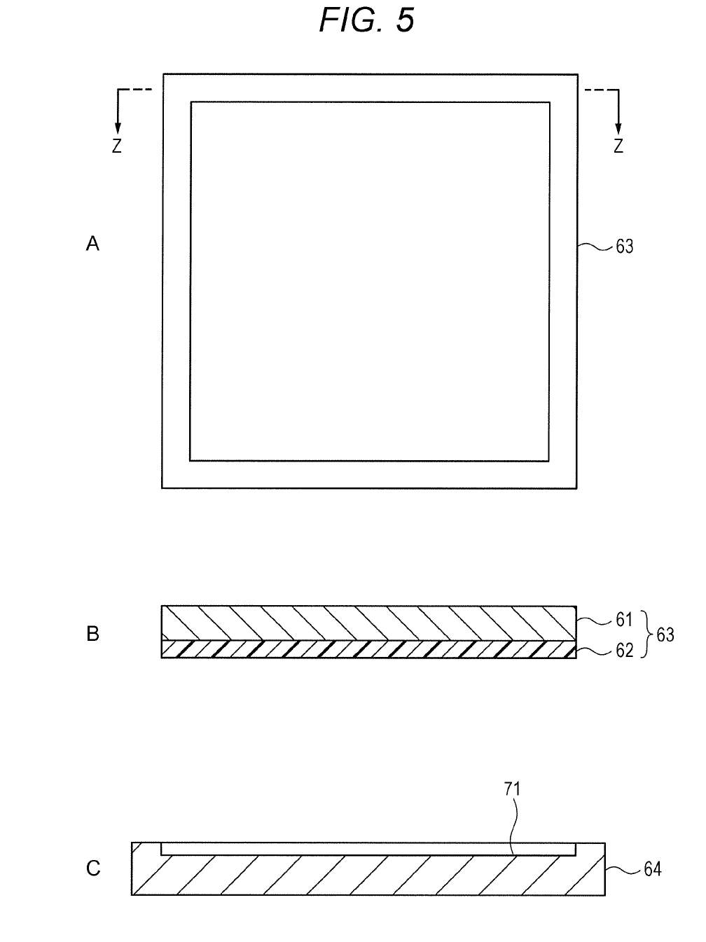

An example of the liquid retaining jig that is used in a liquid retaining method will be described with reference to FIGS. 5A to 5C. FIG. 5A illustrates a schematic diagram illustrating an example of a constituent member of the liquid retaining jig that is used in the liquid retaining method. FIG. 5B illustrates a cross-sectional view taken along a line Z-Z illustrated in FIG. 5A. FIG. 5C illustrates a schematic diagram illustrating an example of a constituent member of the liquid retaining jig. As illustrated in FIGS. 5A to 5C, the liquid retaining jig includes a base plate 64 and a pressing plate 63 that is combined to the base plate 64. For example, the pressing plate 63 has a rectangular frame shape corresponding to a plane external shape of the base plate 64, and is constituted by a base body 61 and a packing 62 that is provided on a surface of the base body 61 on a side to be joined to the base plate 64.

The base material 11 of a dye-adsorbed body W is disposed on a base material mounting portion 71. For example, the dye-adsorbed body W is a photoelectrode base material including a conductive base material having a surface and a porous semiconductor layer formed on the surface. In the photoelectrode base material, the porous semiconductor layer 3, the current collector 43, the protective layer 45, the current collector terminal 7, and the structure 41 are formed on the transparent conductive base material 1.

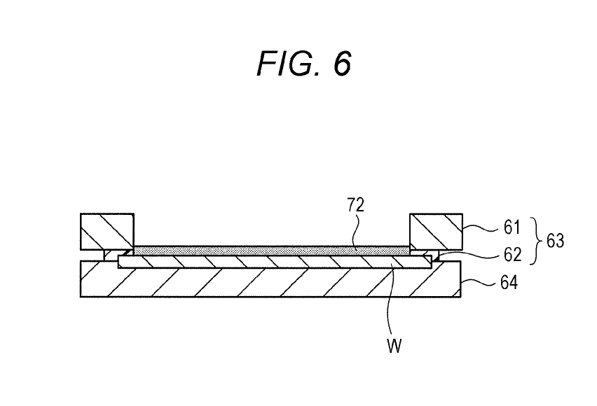

As illustrated in FIG. 6, the pressing plate 63 is combined to the base plate 64 through the dye-adsorbed body W, whereby the rectangular frame-shaped packing 62 is brought into close contact with the dye-adsorbed body W. According to this, a liquid retaining space that surrounds the porous semiconductor layer 3 is formed, and a dye solution 72 is collected in the liquid retaining space to adsorb dye onto the porous semiconductor layer 3.

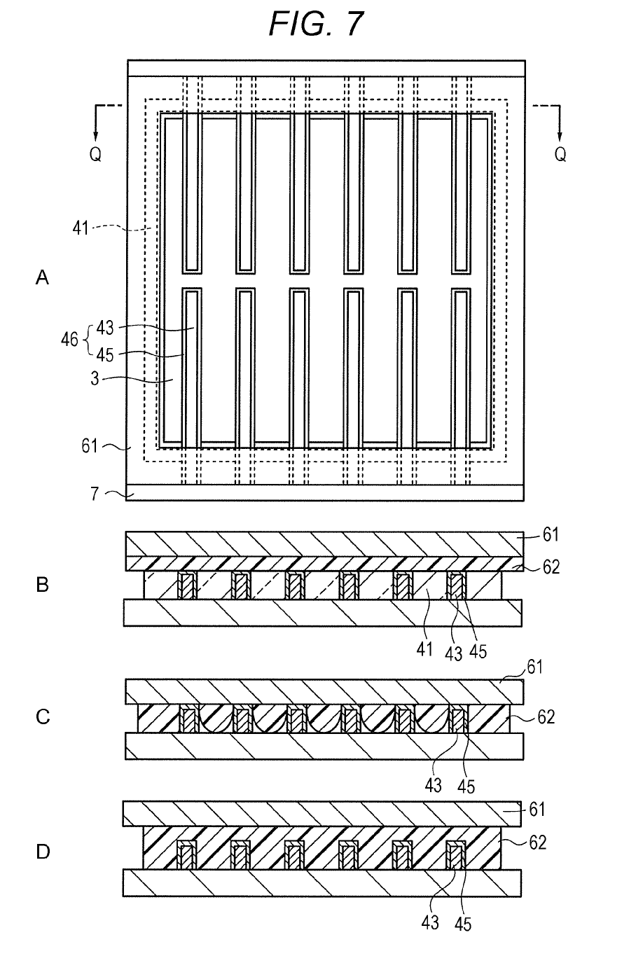

At this time, as illustrated in FIG. 7A, the rectangular frame-shaped packing 62 is joined to a protrusion having a flat surface at a rectangular frame-shaped top portion. The protrusion having the flat surface at the rectangular frame-shaped top portion is formed by the plurality of current collector portions 46 arranged in parallel, the structure 41 embedded in a concave portion between the plurality of current collector portions arranged in parallel, and the structure 41 provided along each of the right side and the left side of the periphery as described above. According to this, as illustrated in FIG. 7B, adhesiveness between the rectangular frame-shaped protrusion and the packing 62 becomes satisfactory, and thus liquid leakage of the dye solution that is collected in the liquid retaining space of the liquid retaining jig may be suppressed. Accordingly, dye adhesion to unnecessary sites or dye contamination on a rear surface of the transparent conductive base material 1 may be prevented, and thus utilization efficiency of dye may be improved. On the other hand, in an immersion method that is generally used in a dye carrying process, since the adsorption is carried out by immersing the entirety of the dye-adsorbed body W in the dye solution, the dye adheres to unnecessary sites such as a rear surface of the base material 11, and the utilization efficiency of the dye decreases. Furthermore, a cleaning process of washing the dye adhered to the unnecessary sites is necessary. In addition, in a subsequent process, the dye adheres to a region in which the sealing material 6 is to be formed. Therefore, sealing properties deteriorate, and this deterioration becomes a cause of a decrease in reliability of a cell or product failure due to leakage of an electrolyte and the like.

As illustrated in FIG. 7C, in a case where the structure 41 is not provided, in a region in which the dye-adsorbed body W and the packing 62 come into close contact with each other, unevenness that is not absorbed by the packing 62 is formed. Therefore, in a case where the structure 41 is not provided, in the region in which the dye-adsorbed body W and the packing 62 come into close contact with each other, adhesiveness with the packing 62 is poor, and thus liquid leakage of the dye solution 72 collected in the liquid retaining space of the liquid retaining jig occurs. In addition, due to this liquid leakage, there is a problem in that a region which is located at the outer peripheral region of the porous semiconductor layer 3 and in which the sealing material 6 is to be formed in a subsequent process is contaminated. When the region in which the sealing material 6 is to be formed is contaminated, cell characteristics and reliability decrease. To suppress the decrease, unintentionally, it is necessary for a cleaning process of removing the dye contaminant to be carried out.

In addition, the structure 41 may not be provided. In this case, as illustrated in FIG. 7D, an uneven shape may be provided in the packing 62 to conform to unevenness of the peripheral portion of the dye adsorption region, for example, unevenness of the region in which the plurality of current collector portions 46 arranged in parallel are disposed. According to this, for example, a convex portion of the packing 62 and a concave portion between the plurality of current collector portions 46 arranged in parallel fit together, and thus a gap disappears between concave portions formed between the plurality of current collector portions 46, and thus liquid leakage of the dye solution collected in the liquid retaining space of the liquid retaining jig may be suppressed. At this time, the packing 62 may cover at least a part of the region in which the sealing material 6 is formed, and a region between the dye adsorption region and the region in which the sealing material 6 is formed.

(Filling of Electrolyte)

Next, an ultraviolet curable adhesive as the sealing material 6 is formed at the peripheral portion of a transparent conductive layer 22 of the transparent conductive base material 2 by a dispenser, and the transparent conductive base material 1 is joined thereto through the ultraviolet curable adhesive. At this time, the porous semiconductor layer 3 and the counter electrode 5 are disposed to be opposite to each other with a predetermined distance, for example, 1 μm to 100 μm, preferably 1 μm to 50 μm. According to this, a space into which an electrolyte layer 4 is filled is formed by the transparent conductive base material 1, the transparent conductive base material 2, and the sealing material 6. Next, for example, the electrolyte is injected through an injection port that is formed in the transparent conductive base material 2 in advance to fill the electrolyte layer 4 in the space. Then, the injection port is closed. According to this, the photoelectric conversion device that is intended is manufactured.

(Manufacturing Example Using Dye Adsorption Device)

The photoelectric conversion device according to the first embodiment of the technique may be manufactured by using the dye adsorption device. Hereinafter, an example of manufacturing the photoelectric conversion device using the dye adsorption device will be described.

(Dye Adsorption Device)

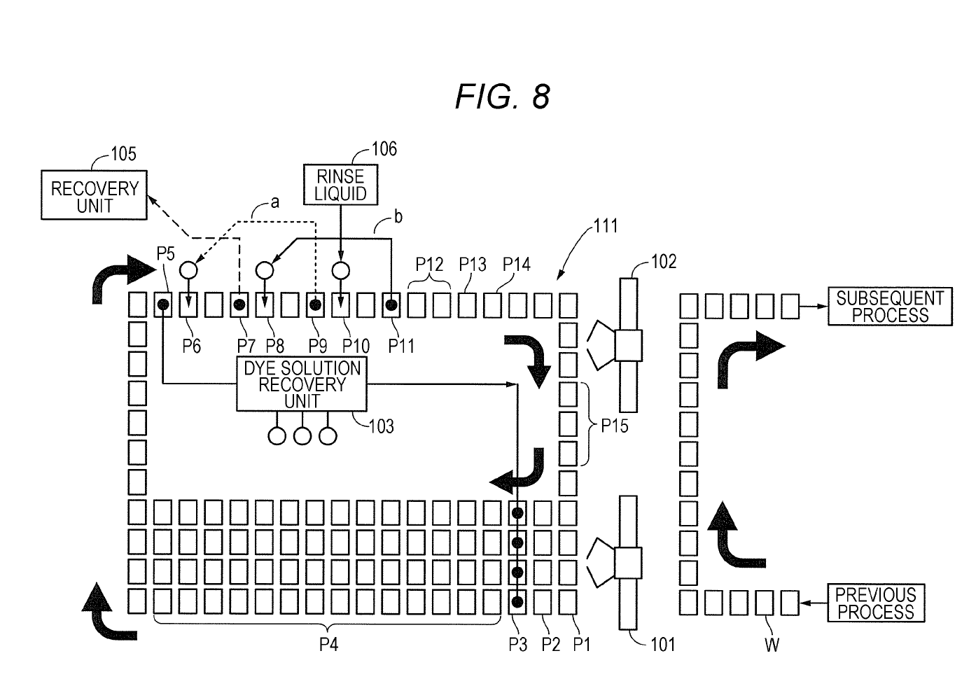

FIG. 8 illustrates a schematic diagram illustrating the outline of the dye adsorption device. In the dye adsorption device, for example, the dye-adsorbed body W is taken out by a substrate loading robot 101 and is transmitted to a conveying unit 111. The dye-adsorbed body W is a body in which the porous semiconductor layer 3, the current collector 43, the protective layer 45, the current collector terminal 7, and the structure 41 are formed on the transparent conductive base material 1 in the previous processes. In addition, as the previous processes, the formation of the transparent conductive base material, the formation of the current collector, the formation of the protective layer, the formation of the porous semiconductor layer, and the baking are carried out. For example, the dye-adsorbed body W has a configuration in which the sealing material 6 is omitted in FIG. 2A. In addition, the dye-adsorbed body W has a rectangular frame-shaped protrusion having a flat surface on the top portion, which is formed by the plurality of current collector portions 46 arranged in parallel, the structure 41 embedded in a concave portion between the plurality of current collector portions arranged in parallel, and the structure 41 provided along each of the right side and the left side of the periphery.

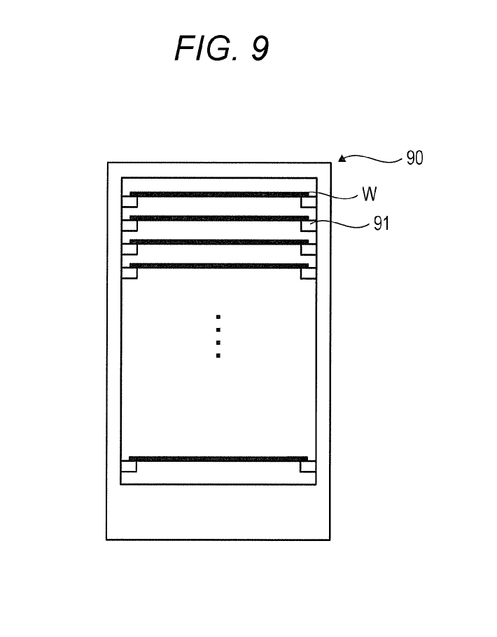

As shown in FIG. 9, after the previous processes, a plurality of the dye-adsorbed body W are placed on shelves 91 of a multi-stage type rack 90, and are conveyed along with the rack 90. For example, the rack 90 may be a rack in which an atmosphere may be controlled, or a rack to which an IC tag is attached to carry out a substrate information management or the like.

In the conveying unit 111, the dye-adsorbed body W is conveyed in the following conveying route along a direction indicated by bold-line arrows in FIG. 8. For example, the conveying unit 111 is a conveyer belt, and the like.

Conveying route: a substrate setting position P1→a jig clamping position P2→a dye injection position P3→a dye adsorption position P4→a dye solution recovery position P5→a first-time rinse liquid injection position P6→a first-time rinse liquid recovery position P7→a second-time rinse liquid injection position P8→a second-time rinse liquid recovery position P9→a third-time rinse liquid injection position P10→a third-time rinse liquid recovery position P11→a drying position P12→an adsorbed amount inspection position P13→a jig unclamping position P14→a subsequent process

In the conveying route, at the respective positions of P1 to P14, respective processes such as a liquid retaining jig fixing, dye adsorption, recovery of the dye solution, injection of the rinse liquid, and recovery of the rinse liquid are carried out with respect to the dye-adsorbed body W. Then, the transparent conductive base material 1 and the transparent conductive base material 2 are joined to each other, and then subsequent processes such as injection of an electrolytic solution are carried out.

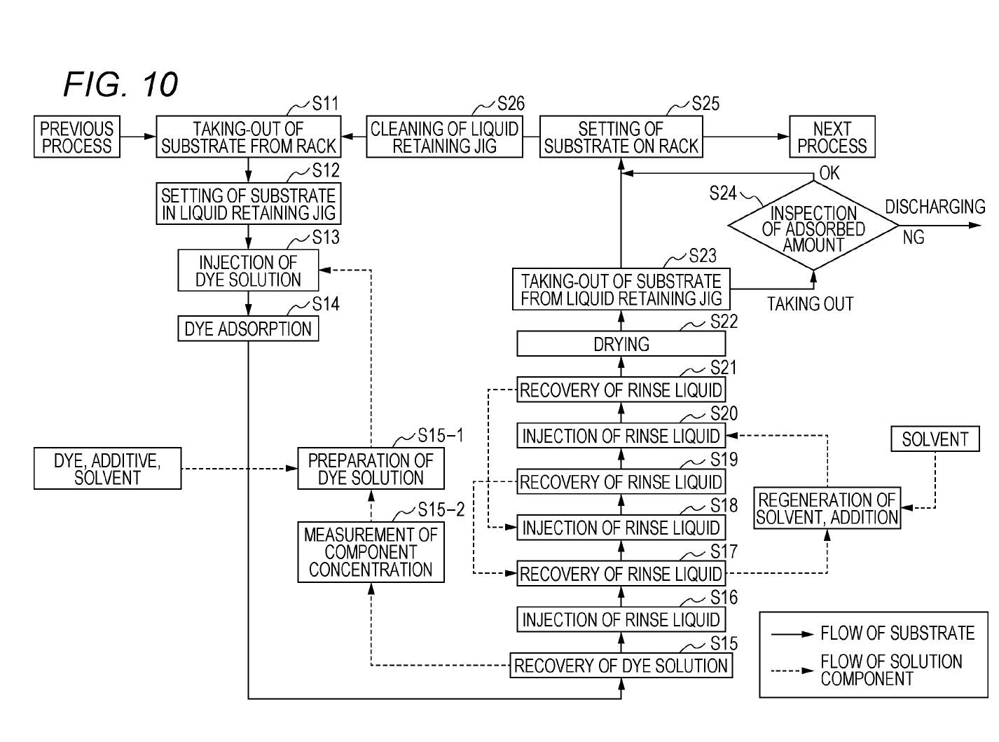

The dye adsorption device will be described in more detail with reference to a flowchart of FIG. 10. In addition, a solid-line arrow in FIG. 10 indicates a moving route of the dye-adsorbed body W. A chain-line arrow indicates a moving route of the solution component such as the dye solution and the rinse liquid, and as shown by the chain-line arrow, a solution component is moved, and recovery and reuse of the dye solution and the rinse solution are carried out.

After previous processes, first, the dye-adsorbed body W is conveyed in the sequence of the substrate setting position P1 and the jig clamping position P2. In step S11, the dye-adsorbed body W, which is accommodated in the rack 90, is taken out by the substrate loading robot 101, and the dye-adsorbed body W is disposed in a liquid retaining jig disposed at the substrate setting position P1. Then, the dye-adsorbed body W, which is disposed in the liquid retaining jig, is conveyed to the jig clamping position P2. In step S12, in the jig clamping position P2, the dye-adsorbed body W is fixed to the liquid retaining jig by a clamp.

(Liquid Retaining Jig)

An example of the liquid retaining jig will be described.

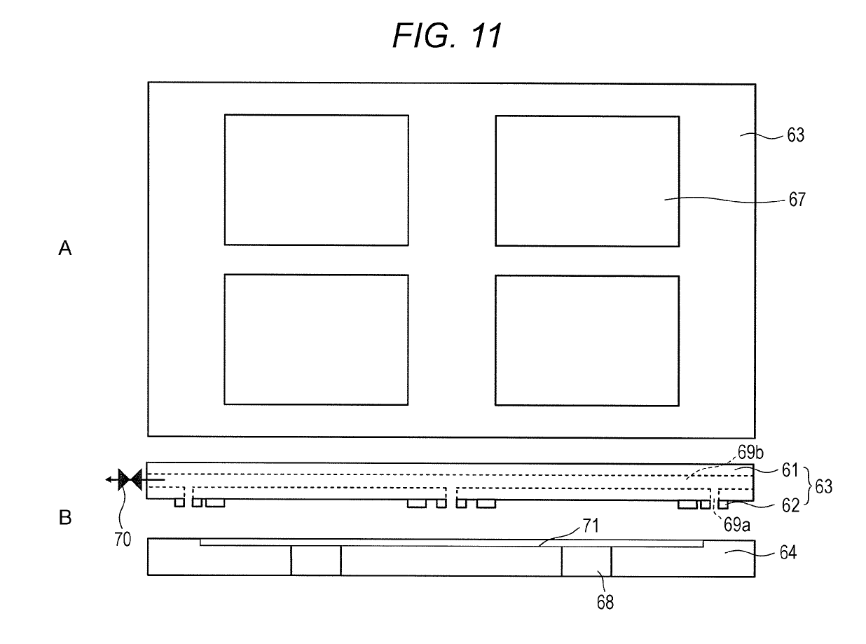

FIG. 11A illustrates a plan view of the pressing plate of the liquid retaining jig. FIG. 11B illustrates a cross-sectional view of the pressing plate and the base plate. As shown in FIGS. 11A and 11B, the liquid retaining jig includes the base plate 64 and the pressing plate 63 that is combined to the base plate 64. For example, the pressing plate 63 has a rectangular shape corresponding to the plane external shape of the base plate 64, and is constituted by the base body 61 and the packing 62 that is provided on a surface of the base body 61 on a side to be joined to the base plate 64 of the base body 61. For example, the pressing plate 63 may be constituted by two layers of a SUS plate suitable for securing rigidity, and a Teflon plate (Teflon is a registered trade mark) for prevention of corrosion at a solution contact portion. For example, the packing 62 may be formed by an elastic material such as silicone rubber. In the pressing plate 63, four rectangular-shaped openings 67 are provided, and the rectangular frame-shaped packing 62 is provided at the peripheral portion of the openings 67 along the outer periphery of each of the openings 67. In addition, for example, 2, 3, or 5 or more openings 67 may be provided. For example, in a state in which the dye-adsorbed body W is mounted on the base plate 64, and the pressing plate 63 is disposed on the dye-adsorbed body W, each of the openings 67 is provided at a position corresponding to a region in which the porous semiconductor layer 3 onto which dye is to be adsorbed is formed. In a state in which the dye-adsorbed body W is mounted on the base plate 64, and the pressing plate 63 is disposed on the dye-adsorbed body W, the liquid retaining space may be formed by the openings 67. An exhaust path 69b for evacuation is provided inside the pressing plate 63. In addition, a plurality of suction holes 69a that are connected to the exhaust path 69b are provided between the packings 62. A suction force is generated in the suction hole 69a due to exhaust by an exhaust valve 70 that is connected to the exhaust path 69b, and according to the suction force, the pressing plate 63 and the base plate 64 are fixed to each other.

The base plate 64 includes a concave base material mounting portion 71 on which the base material 11 of the dye-adsorbed body W is mounted. A supporting column through-hole 68 is formed in the bottom surface of the base material mounting portion 71. The supporting column through-hole 68 is provided to allow a supporting column to pass therethrough. The supporting column pushes up the dye-adsorbed body W when detaching the dye-adsorbed body W from the liquid retaining jig to confirm whether or not the dye-adsorbed body W is set in the liquid retaining jig.

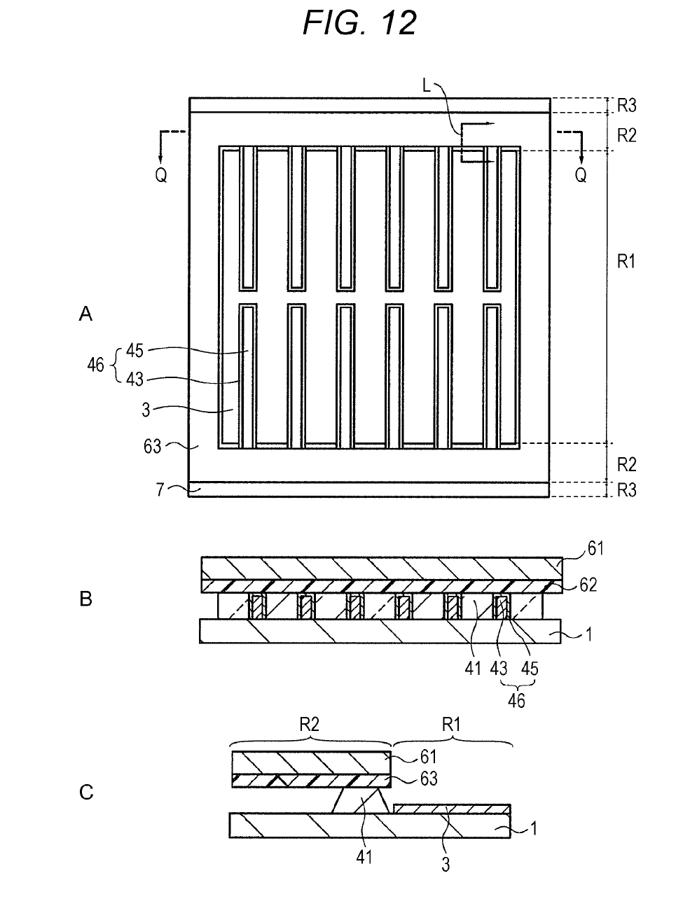

FIG. 12A illustrates a state in which the dye-adsorbed body W is fixed to the liquid retaining jig. FIG. 12B illustrates a cross-sectional view taken along a line Q-Q shown in FIG. 12A. FIG. 12C illustrates a cross-sectional view taken along a line L shown in FIG. 12A. In a dye adsorption process to be described later, a dye adsorption solution is collected in a liquid retaining space of the liquid retaining jig which is formed to surround to the dye-adsorbed body W in a state in which the dye-adsorbed body W shown in FIGS. 12A to 12C is fixed to the liquid retaining jig. Accordingly, the dye is adsorbed onto the porous semiconductor layer 3.

At this time, the rectangular frame-shaped packing 62 is disposed in the region R2 between the region R1 in which the porous semiconductor layer 3 onto which dye is to be adsorbed is formed, and the region R3 in which the current collector terminal 7 is formed. In addition, as shown in FIGS. 12B and 12C, the surface of the rectangular frame-shape packing 62 is joined to the rectangular frame-shaped protrusion having a flat surface on the top portion which is obtained by the structure 41. Accordingly, adhesiveness between the rectangular frame-shaped protrusion and the packing 62 becomes satisfactory.

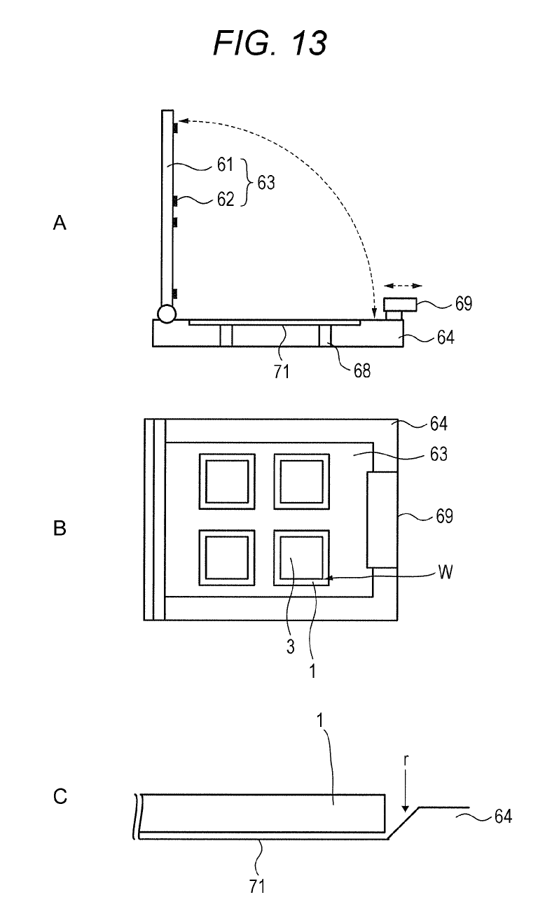

For example, in the configuration of the liquid retaining jig, as shown in FIG. 13A, the pressing plate 63 may be attached to the base plate 64 in an openable and closable manner in an arrow direction by allowing one side of the pressing plate 63 to be axially supported by one side of the base plate 64. FIG. 13B illustrates a state in which, in the liquid retaining jig shown in FIG. 13A, the pressing plate is combined to the base plate. As shown in FIG. 13B, the dye-adsorbed body W, in which the porous semiconductor layer 3 is formed in a lattice shape on the transparent conductive base material 1, is disposed on the base plate 64. Ina state of being combined to the base plate 64 through the dye-adsorbed body W, the pressing plate 63 is fixed by a clamp 69 provided on one side of the base plate 64. In addition, although not shown, a drainage groove through which a solution such as the dye solution is drained may be provided in the base plate 64. The drainage groove may be provided in the vicinity of the outer periphery of the liquid retaining space in which the dye solution is collected. In addition, in FIG. 13C, as indicated by an arrow r, a taper shape for positioning of the transparent conductive base material 1 of the dye-adsorbed body W may be provided in the peripheral portion of the base material mounting portion 71.

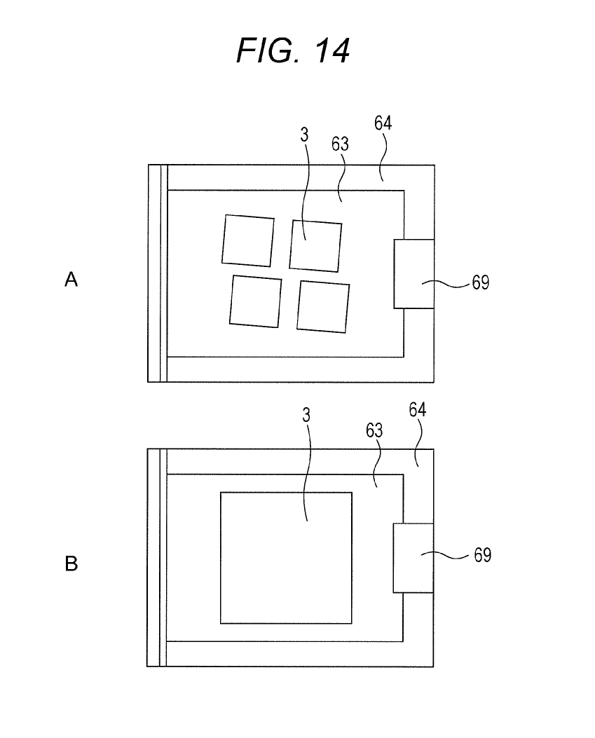

In addition, for example, as shown in FIG. 14A, the porous semiconductor layer 3 shown in FIG. 13B, which is disposed in a lattice shape on the transparent conductive base material 1, may be disposed obliquely with respect to the longitudinal direction or the short-length direction of the base plate 64. As shown in FIG. 14B, the transparent conductive base material 1 in which one flat rectangular porous semiconductor layer 3 is provided may be disposed in the liquid retaining jig.

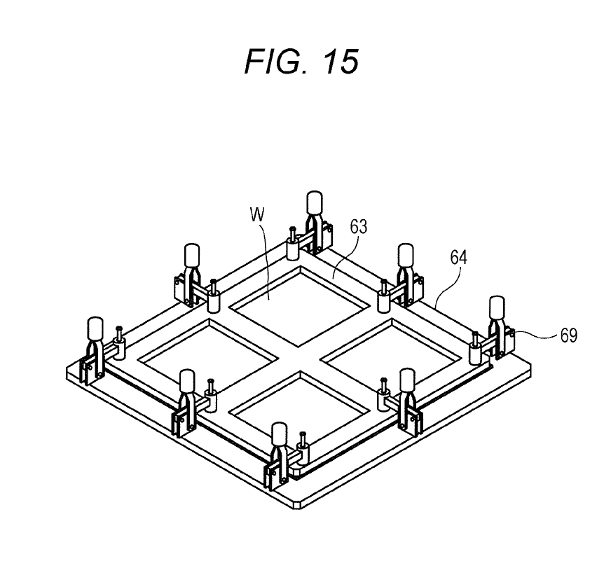

In addition, with regard to the configuration of the liquid retaining jig, for example, as shown in FIG. 15, after the pressing plate 63 is assembled to the base plate 64 through the dye-adsorbed body W, the pressing plate 63 may be fixed by clamp 69 which is provided at the centers and both ends of two opposing sides of the base plate, and the centers of the other two opposing sides, respectively.

(Another Example of Liquid Retaining Jig)

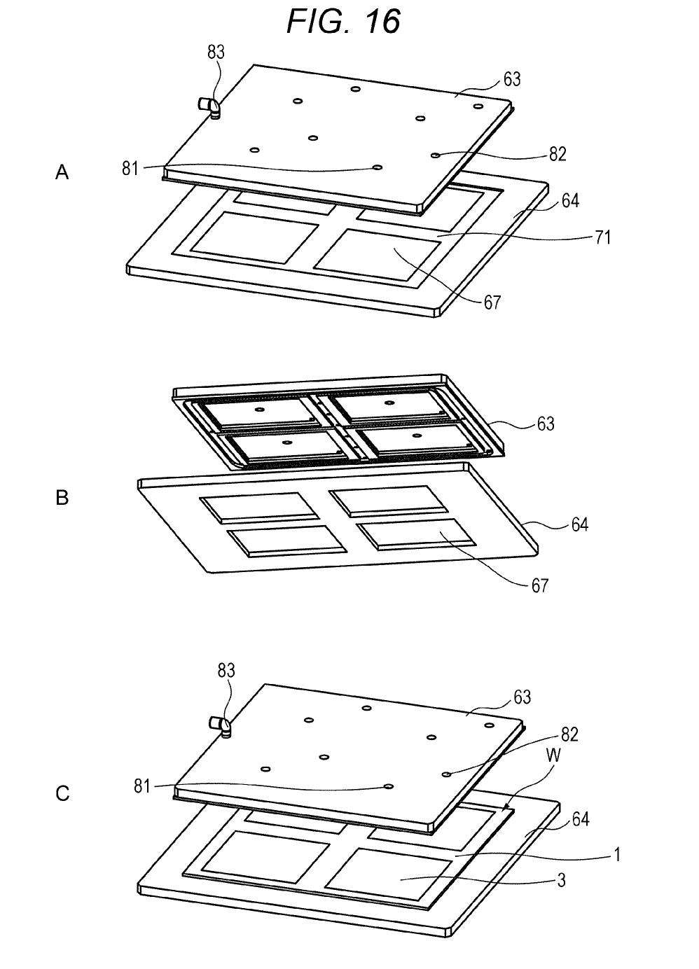

Another example of the liquid retaining jig will be described. In another example of the liquid retaining jig, the pressing plate 63 of the liquid retaining jig is formed in a lid shape. FIGS. 16A to 16C show exploded perspective views of another example of the liquid retaining jig. FIG. 16A illustrates an exploded perspective view in a case of observing the liquid retaining jig from an obliquely upper side. FIG. 16B illustrates an exploded perspective view in a case of observing the liquid retaining jig from an obliquely lower side. FIG. 16C illustrates an exploded perspective view in a case of observing the liquid retaining jig to which the dye-adsorbed body is fixed from an obliquely upper side.

As shown in FIGS. 16A and 16B, the liquid retaining jig includes a lid-shaped pressing plate 63 and a base plate 64 on which the transparent conductive base material 1 of the dye-adsorbed body W is mounted. The base plate 64 includes a concave base material mounting portion 71 on which the transparent conductive base material 1 is mounted, and four rectangular openings 67 are formed in the bottom of the base plate 64. The transparent conductive base material 1 in which the porous semiconductor layer 3 is formed is mounted on the base material mounting portion 71. The lid-shaped pressing plate 63 is a lid-shaped member that is capable of covering the concave base material mounting portion 71. After the dye-adsorbed body W is disposed at the base material mounting portion 71, the dye-adsorbed body W is covered with the lid-shaped pressing plate 63, thereby forming a hermetically sealed space such as hermetically sealed liquid retaining space. Accordingly, suppression of volatilization of the dye solution, suppression of entrance of the external moisture, and the like may be realized. The lid-shaped pressing plate 63 has an injection hole 81 through which a solution such as a rinse liquid or a dye solution is injected, and a drainage 82 through which the solution such as the rinse liquid or the dye solution is drained. The drainage hole 82 is preferably provided at a position corresponding to the vicinity of the liquid retaining space that is formed by close contact of the packing 62 through the dye-adsorbed body W. In addition, an exhaust nozzle 83 is provided in the lid-shaped pressing plate 63. In addition, the injection hole 81 and the drainage hole 82 may be configured by one hole, and liquid injection and drainage may be carried out using the one hole. Two or more injection holes 81 may be provided. In addition, two or more drainage holes 82 may be provided.

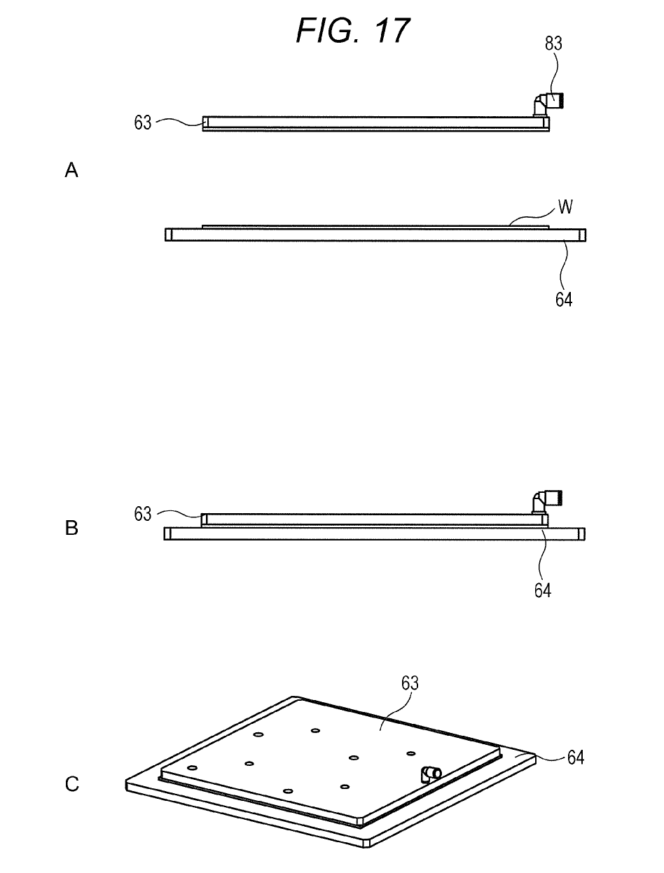

As shown in FIGS. 17A to 17C, in a state in which the lid-shaped pressing plate 63 is combined to the base plate 64 by combining the lid-shaped pressing plate 63 to the base plate 64 through the dye-adsorbed body W while the dye-adsorbed body W is mounted on the base plate 64, when the base plate 64 and the lid-shaped pressing plate 63 are fixed to each other by evacuation from an exhaust nozzle 83, the dye-adsorbed body W is fixed to the liquid retaining jig. A clamp may be provided to fix the base plate 64 and the lid-shaped pressing plate 63.

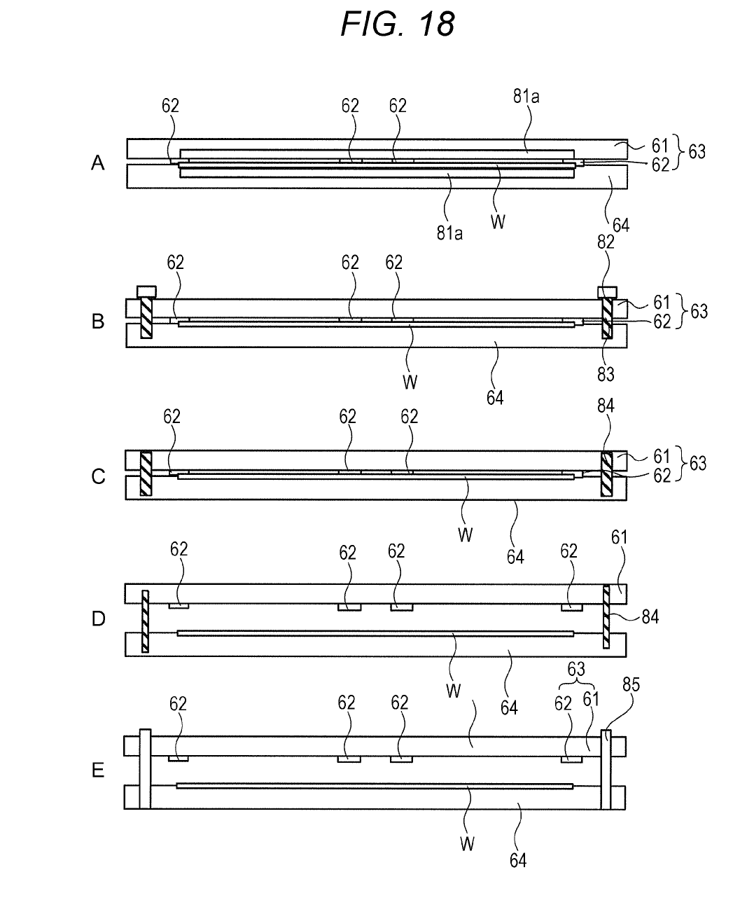

In addition, in an example shown in FIGS. 17A to 17C, the lid-shaped pressing plate 63 and the base plate 64 are fixed to each other by evacuation, but a method for fixing the pressing plate 63 and the base plate 64 is not limited thereto. For example, as is the case with a first fixing example to a fourth fixing example which are shown in FIGS. 18A to 18D, the pressing plate 63 and the base plate 64 may be fixed to each other by interposing the dye-adsorbed body W between the pressing plate 63 and the base plate.

### FIRST FIXING EXAMPLE

FIG. 18A illustrates a cross-sectional view illustrating a first fixing example of the pressing plate 63 and the base plate 64. The dye-adsorbed body W is disposed on the base plate 64, and then the dye-adsorbed body W may be pressed against the base plate 64 through the packing 62 by the pressing plate 63. A magnet 81a is provided to the pressing plate 63 on a side to be combined to the base plate 64, and a magnet 81b is provided to the base plate 64 on a side to be combined to the pressing plate. Due to a magnetic force of the magnets, the pressing plate 63 and the base plate 64 are fixed in a state of being combined through the dye-adsorbed body W.

### SECOND FIXING EXAMPLE

FIG. 18B illustrates a cross-sectional view illustrating a second fixing example of the pressing plate 63 and the base plate 64. The dye-adsorbed body W is disposed on the base plate 64, and then the dye-adsorbed body W may be pressed against the base plate 64 through the packing 62 by the pressing plate 63. A screw hole 82 is provided to both ends of the pressing plate 63 and the base plate 64, respectively. In a state in which the pressing plate 63 and the base plate 64 are combined through the dye-adsorbed body W, a screw 83 is inserted into the screw hole 82, thereby screw fastening is carried out. Accordingly, the pressing plate 63 and the base plate 64 are fixed to each other in a state of being combined through the dye-adsorbed body W.

### THIRD FIXING EXAMPLE

FIGS. 18C and 18D show cross-sectional views illustrating a third fixing example of the pressing plate 63 and the base plate 64. The dye-adsorbed body W is disposed on the base plate 64, and then the dye-adsorbed body W may be pressed against the base plate 64 through the packing 62 by the pressing plate 63. The pressing plate 63 and the base plate 64 enter two states including a fixed state shown in FIG. 18C and a fixing release state shown in FIG. 18D by an elastic body 84 such as a spring which is provided at both ends of the pressing plate 63 and the base plate 64. In the fixed state shown in FIG. 18C, the pressing plate 63 and the base plate 64 are fixed to each other in a state of being combined through the dye-adsorbed body W by an elastic force of the elastic body 84.

### FOURTH FIXING EXAMPLE

FIG. 18E illustrates a cross-sectional view illustrating a fourth fixing example of the pressing plate 63 and the base plate 64. The dye-adsorbed body W is disposed on the base plate 64, and then the dye-adsorbed body W may be pressed against the base plate 64 through the packing 62 by the pressing plate 63. The base plate 64 may vertically elevate by a cylinder 85 provided on both ends of the pressing plate 63 and the base plate 64. The pressing plate 63 and the base plate 64 are fixed to each other in a state in which the pressing plate 63 and the base plate 64 are combined to each other through dye-adsorbed body W by descending the base plate 64.

Next, the dye-adsorbed body W, which is fixed to the liquid retaining jig, is conveyed to the dye injection position P3. In step S13, in the dye injection position P3, the dye solution is injected into the liquid retaining jig. Accordingly, the dye solution 72 is collected in the liquid retaining space of the liquid retaining jig, which surrounds the porous semiconductor layer 3. Then, the dye-adsorbed body W, which is fixed to the liquid retaining jig, is conveyed to the dye adsorption position P4, and in step S14, dye adsorption is carried out for a predetermined time. In the dye adsorption position P4, the dye solution 72 penetrates into the porous semiconductor layer 3, and adsorption of the dye with respect to the porous semiconductor layer 3 is in progress.

Next, the dye-adsorbed body W, which is fixed to the liquid retaining jig, is conveyed to the dye solution recovery position P5. In step S15, in the dye solution recovery position P5, a surplus dye solution that remains in the liquid retaining jig is recovered.

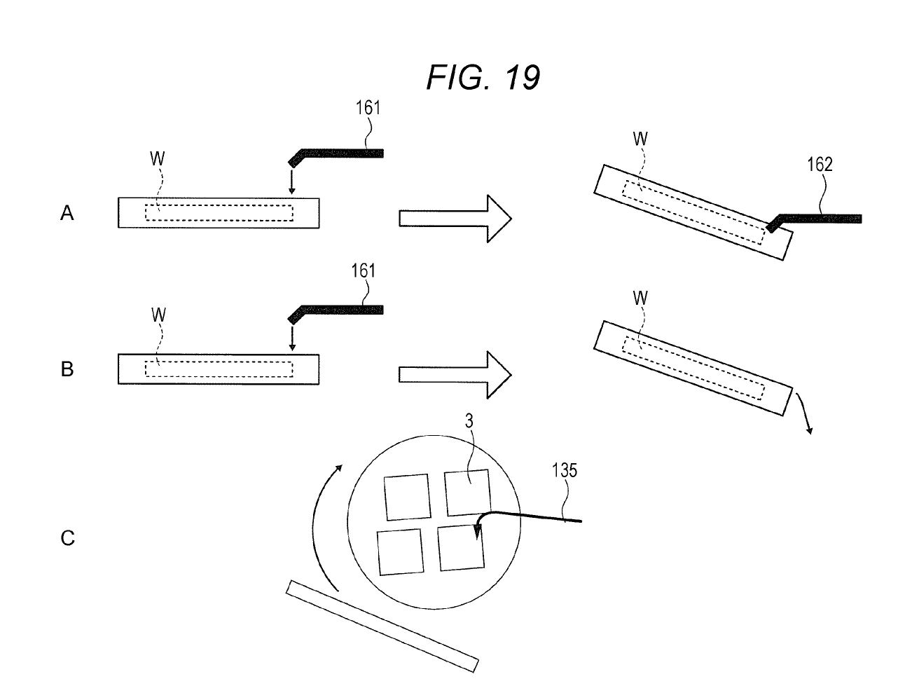

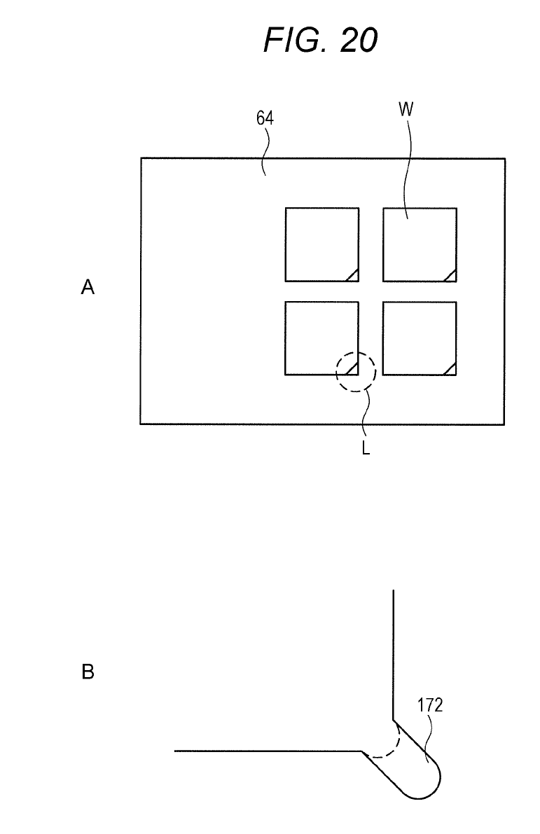

Here, an injection method and a recovery method of the dye solution at the dye injection position P3 and the dye solution recovery position P5 will be described. FIG. 19A illustrates a schematic diagram illustrating a first configuration example of the dye solution injection method and the dye solution recovery method. FIG. 19B illustrates a schematic diagram illustrating a second configuration example of the dye solution injection method and the dye solution recovery method. FIG. 19C illustrates a schematic diagram illustrating a modification example of the dye solution injection method. FIGS. 20A and 20B show schematic diagrams illustrating an example of a drainage method.

In the example of FIG. 19A, at the dye injection position P3, the dye solution is injected into the liquid retaining jig from a nozzle 161. At the dye solution recovery position P5, the dye solution is recovered from a nozzle 162 by sucking the dye solution from the liquid retaining jig. At this time, as shown in FIG. 19A, when the liquid retaining jig is inclined, the dye solution is collected at a part of the liquid retaining jig, and thus recovery of the dye solution becomes easy.

In the example of FIG. 19B, at the dye injection position P3, the dye solution is injected into the liquid retaining jig from the nozzle 161. At the dye solution recovery position P5, as shown in FIG. 19B, the dye solution is drained by inclining the liquid retaining jig. At this time, when the drainage is carried out in such a manner that the liquid retaining jig is obliquely inclined to collect the dye solution as shown in FIG. 20A in a solution recovery groove 172 shown in FIG. 20B, which is provided at a corner L of the base plate 64, and a nozzle is put into the drainage groove to suck the dye solution, contact between the nozzle and the base material 11 of the dye-adsorbed body W may be prevented during drainage. In addition, in place of the recovery groove 172, the drainage may be carried out using a recovery hole.

In the example shown in FIG. 19B, at the dye injection position P3, the dye solution is injected into the liquid retaining jig from the nozzle 161. At the dye solution recovery position P5, as shown in FIG. 19B, the dye solution is drained by inclining the liquid retaining jig. At this time, for example, when the drainage is carried out in such a manner that the liquid retaining jig is obliquely inclined to collect the dye solution as shown in FIG. 20A in the solution recovery groove 172 shown in FIG. 20B, which is provided at the corner L of the base plate 64, and a nozzle is put into the drainage groove to suck the dye solution, contact between the nozzle and the base material 11 of the dye-adsorbed body W may be prevented during the drainage.

In addition, as shown in FIG. 19C, during injection of the dye solution, the dye solution may be injected while rotating the liquid retaining jig in order for the dye solution to reach the entirety of the liquid retaining jig. Accordingly, even in a small amount of dye solution, dye may be uniformly adsorbed onto the porous semiconductor layer 3. In addition, even when an injection site of the dye solution may be fixed to one side, since the liquid retaining jig is rotated, treatment of a plurality of substrates is possible. In addition, at least any one operation of inclination, vibration, and rotation may be carried out with respect to the liquid retaining jig during injection of the dye solution.

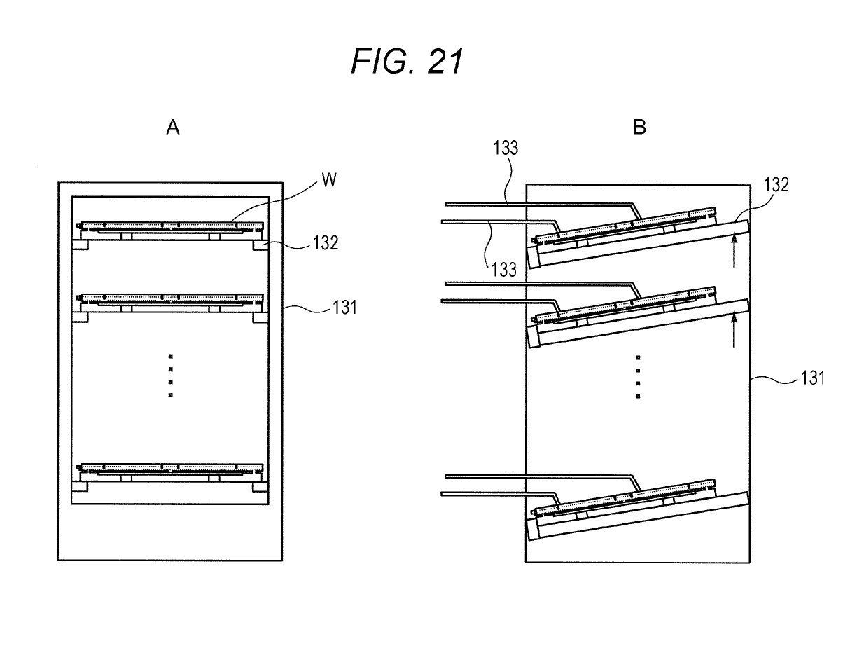

In conveying from the dye injection position P3 to the dye solution recovery position P5, for example, as shown in FIG. 21A, a plurality of the dye-adsorbed body W, which are disposed in the liquid retaining jig, may be conveyed by disposing the plurality of bodies W on a plurality of shelves 132 of the multi-stage type rack 131, which are disposed with a distance in the vertical direction. Each of the shelves 132 is an inclination mechanism and is a member which supports both ends of the liquid retaining jig along the both ends thereof. For example, during recovery of the dye solution, one of the both ends of the shelf 132 may be elevated in a direction shown by an arrow, and thus the liquid retaining jig supported by the shelf 132 may enter an inclined state. A movable suction nozzle 133 may be disposed at a lower end portion of the inclined liquid retaining jig. The dye solution collected at the lower end portion of the inclined liquid retaining jig may be recovered by the suction nozzle 133.

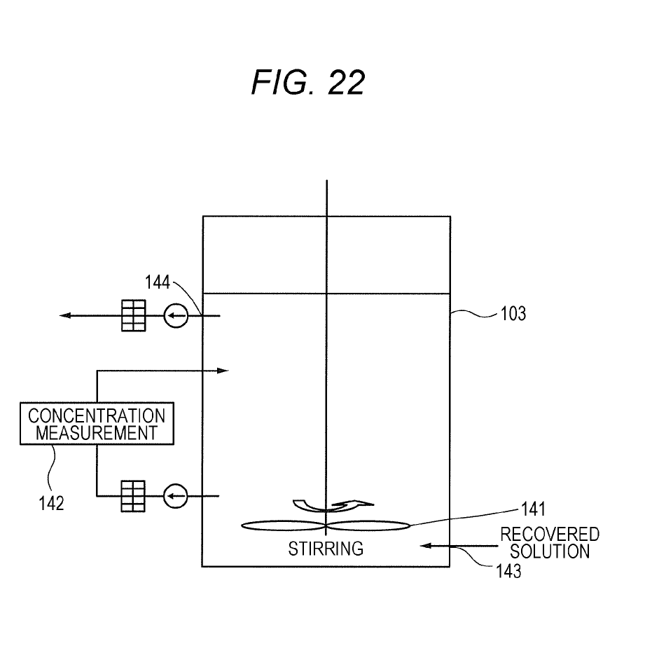

The recovered dye solution is reused after being subjected to component adjustment at the dye solution recovery unit 103. The dye solution recovery unit 103 is, for example, a recovery tank shown in FIG. 22. For example, the recovery tank is an explosion-proof thermostatic jacket type, and includes a stirring unit 141, a concentration measurement unit 142, a dye solution inlet 143, and a dye solution outlet 144. The concentration of the dye solution that has been recovered is measured by the concentration measurement unit, and dye, an additive, a solvent for flow rate control, and the like are appropriately input to the recovered dye solution, and then the resultant solution is stirred by the stirring unit 141, whereby the dye solution is adjusted to a predetermined concentration. Then, the resultant dye solution is transmitted from the dye solution outlet 144 to the dye injection position, and is reused.

Next, in step S16, the liquid retaining jig is conveyed to the first-time rinse liquid injection position P6, and the rinse liquid is injected into the liquid retaining jig at the first-time rinse liquid injection position P6. In step S17, the liquid retaining jig is conveyed to the first-time rinse liquid recovery position P7, and the rinse liquid injected into the liquid retaining jig is recovered at the fist-time rinse liquid recovery position P7. In the first-time rinse liquid injection, for example, as shown by an arrow a, a rinse liquid, which is recovered at the second-time rinse liquid recovery position P9 to which the liquid retaining jig is conveyed later in relation to the first-time rinse liquid injection position P6, may be used. This is because even when a rinse liquid into which dye is mixed to a certain degree is used at the first-time rinsing, a problem does not particularly occur.

Next, in step S18, the liquid retaining jig is conveyed to the second-time rinse liquid injection position P8, and the rinse liquid is injected to the liquid retaining jig at the second-time rinse liquid injection position P8. In step S19, the liquid retaining jig is conveyed to the second-time rinse liquid recovery position P9, and the rinse liquid injected into the liquid retaining jig is recovered at the second-time rinse liquid recovery position P9. At the second-time rinse liquid injection, for example, as indicated by an arrow b, a rinse liquid, which is recovered at the third-time rinse liquid recovery position P11 to which the liquid retaining jig is conveyed later in relation to the second-time rinse liquid injection position P8, may be used. This is because even when a rinse liquid into which dye is mixed to a certain degree is used at the second-time rinsing, a problem does not particularly occur. When the rinsing is carried out plural times by reusing the recovered rinse liquid in the rinsing which is carried out previously than the rinse liquid recovery, and an amount of the rinse liquid may be decreased.

Next, in step S20, the liquid retaining jig is conveyed to the third-time rinse liquid injection position P10, and the rinse liquid is injected to the liquid retaining jig at the third-time rinse liquid injection position P10. In step S21, the liquid retaining jig is conveyed to the third-time rinse liquid recovery position P11, and the rinse liquid injected to the liquid retaining jig is recovered at the third-time rinse liquid recovery position P11. In the third-time rinse liquid injection, the rinse liquid is injected from a rinse liquid injection unit 106. At the third-time rinse liquid injection position, a rinse liquid, which is re-prepared and regenerated in step S17 by adding a solvent and the like to the rinse liquid recovered at the first-time rinse liquid recovery position P7, may be used.

The rinse liquid recovered at the first-time rinse liquid recovery position P7 is recovered, for example, to a recovery unit 105 such as a rinse liquid and dye solution recovery tank that is provided separately. Then, in step S15-1, the dye solution recovery unit 103 measures a component concentration, and then in step S15-2, according to necessity, dye solution components such as dye, an additive, and solvent are added to the recovered dye solution to carry out component adjustment of the dye solution. Then, the resultant dye solution may be reused.

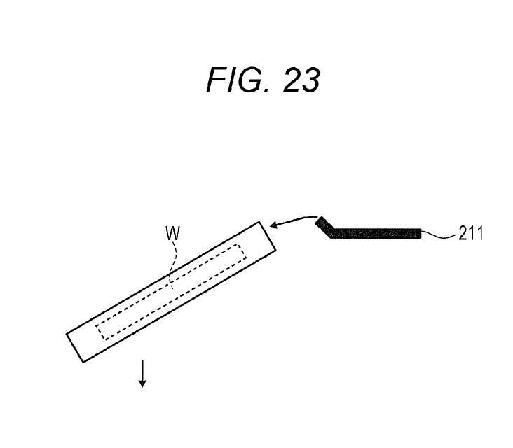

At the rinse liquid injection position, the same method as the above-described injection method of the dye solution may be employed. In addition, at the rinse liquid injection position, as illustrated in the schematic diagram of FIG. 23, a pouring method in which the dye solution is poured from a nozzle 211 to the dye-adsorbed body W may be employed. In the pouring method, the dye solution is allowed to flow from an upper side of the porous semiconductor layer to a lower side thereof while maintaining the liquid retaining jig in order for the dye-adsorbed body W to face an oblique lower direction. In the pouring method, there are advantages such as a rinse injection process and a rinse recovery process may be carried out by one time operation, washing of the liquid retaining jig may be also carried out, and the like.

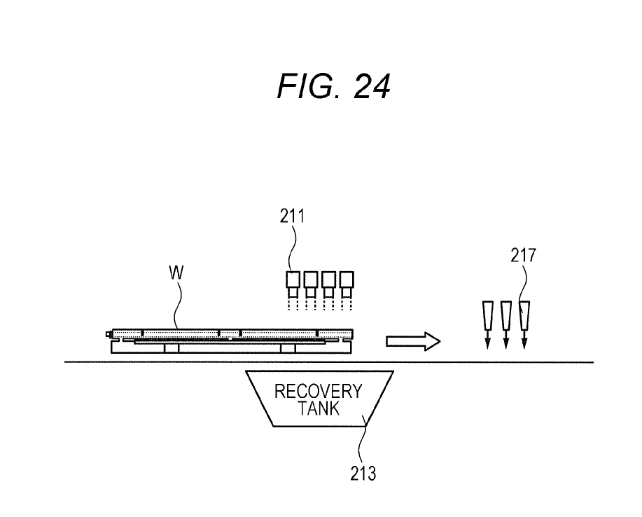

At each of the rinse liquid recovery positions, for example, as illustrated in FIG. 24, the rinse liquid, which is injected to the conveyed dye-adsorbed body W from the nozzle 211, is recovered to the recovery tank 213.

Next, the dye-adsorbed body W, which is fixed to the liquid retaining jig, is conveyed to the drying position P12. In step S22, at the drying position P12, a drying process of the dye-adsorbed body W is carried out. For example, as illustrated in FIG. 24, the drying process of the dye-adsorbed body W is carried out with respect to the dye-adsorbed body W during conveyance by an air flow 217 or the like.

Next, the dye-adsorbed body W, which is fixed to the liquid retaining jig, is conveyed to the adsorbed amount inspection position P13. In step S23 and S24, at the adsorbed amount inspection position P13, the dye-adsorbed body W is taken out from the liquid retaining jig, and a process of inspecting an adsorbed amount of the dye adsorbed onto the porous semiconductor layer is carried out. In the inspection process, in a case where the adsorbed amount is less than a predetermined dye adsorption amount, the dye-adsorbed body W is determined as a defective item and is excluded from the conveying route. In a case where the adsorbed amount is more than a predetermined dye adsorption amount, the body W is determined as a good item.

Next, the dye-adsorbed body W, which is determined as a good item, is conveyed to the jig unclamp position P14, and at the jig unclamp position P14, clamping of the liquid retaining jig is released. Next, in step S25, the dye-adsorbed body W is taken out from the conveying route by a substrate taking out robot 102, and the dye-adsorbed body W, to which dye is adsorbed, is disposed at a predetermined position of a rack. As the rack, the rack 90 which is used after the above-described previous process may be used. Then, with respect to the dye-adsorbed body W onto which dye is adsorbed, subsequent processes such as filling of an electrolyte and bonding of a counter substrate are carried out to obtain a photoelectric conversion device. On the other hand, the liquid retaining jig from which the dye-adsorbed body W is taken out is conveyed to the jig cleaning position P15. In step S26, at the jig cleaning position P15, a dye contaminant adhered to the liquid retaining jig or the like is washed. The washed liquid retaining jig may be used again in step S11.

[Operation of Photoelectric Conversion Device]

Next, the operation of the photoelectric conversion device according to the first embodiment of the technique will be described.

When light L is incident to a light receiving surface of the transparent conductive base material 1, the photoelectric conversion device operates as a battery in which the counter electrode 5 is set as a positive electrode, and the transparent conductive layer 12 is set as a negative electrode. The principle of the operation is as follows.

When the sensitizing dye absorbs photons that are transmitted through the base material 11 and the transparent conductive layer 12, electrons in the sensitizing dye are excited from a ground state (HOMO) to an excited state (LUMO). The electrons in an excited state appears in a conduction band of the porous semiconductor layer 3 through an electrical bands between the sensitizing dye and the porous semiconductor layer 3, and reach the transparent conductive layer 12 through the porous semiconductor layer 3.

On the other hand, the sensitizing dye that lost the electrons receives electrons from a reducing agent in the electrolyte layer 4, for example, from I⁻ by the following reaction, and generates an oxidizing agent in the electrolyte layer 4, for example, I₃⁻ (a bonded substance of I₂ and I⁻).

2I⁻→I₂+2e⁻

I₂+I⁻→I₃⁻

The generated oxidizing agent, for example, I₃⁻ reaches the counter electrode 5 by diffusion, receives electrons from the counter electrode 5, for example, by the following reaction (a reverse reaction of the above-described reaction), and is reduced to the original reducing agent, for example, I⁻.

I₃⁻→I₂+I⁻

I₂+2e⁻→2I⁻

The electrons that are transmitted to an external circuit from the transparent conductive layer 12 perform electrical work at the external circuit, and then return to the counter electrode 5. In this manner, light energy is converted to electrical energy without remaining any change in the sensitizing dye and the electrolyte layer 4.

### 2. SECOND EMBODIMENT

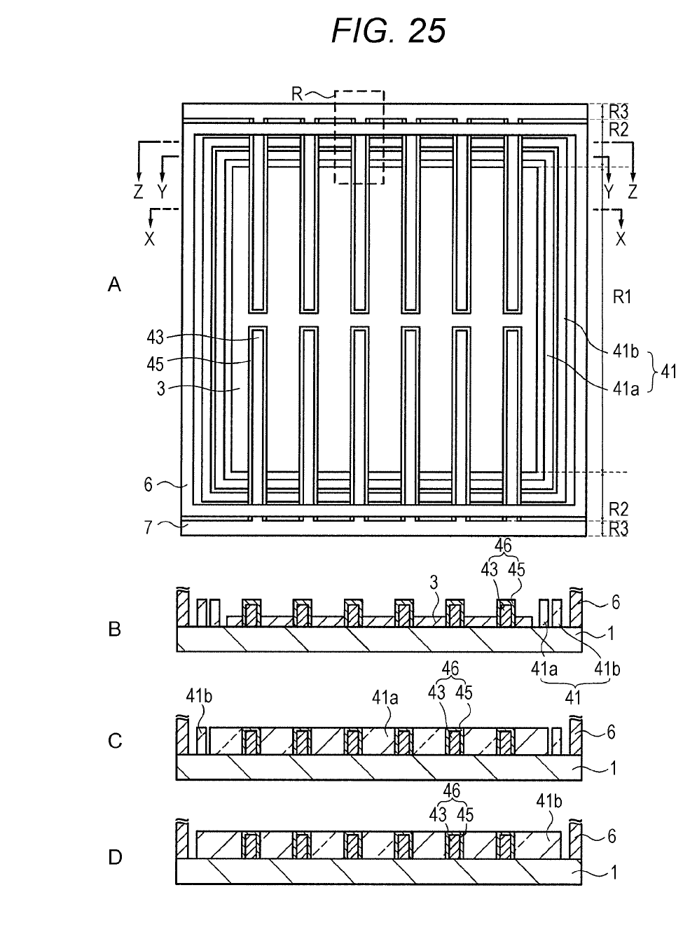

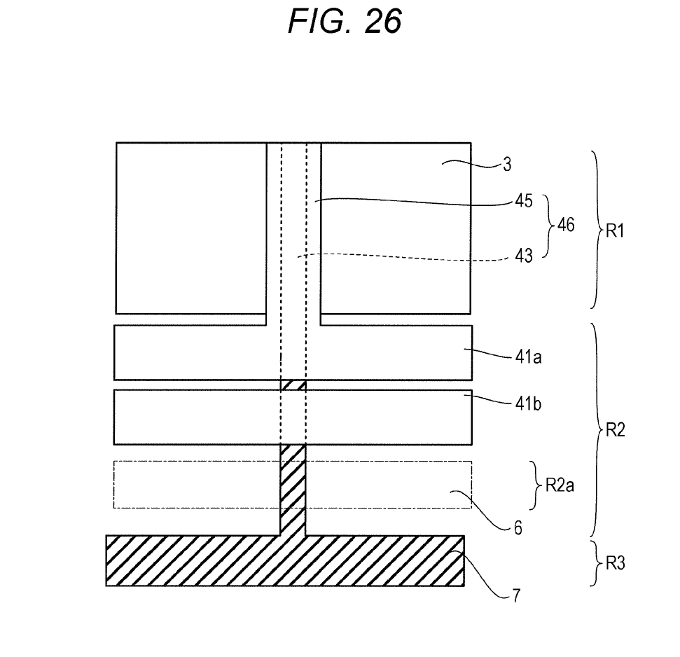

A photoelectric conversion device according to a second embodiment of the technique will be described. FIG. 25A illustrates a plan view in which a transparent conductive base material is omitted. FIG. 25B illustrates a cross-sectional view taken along a line X-X illustrated in FIG. 25A. FIG. 25C illustrates a cross-sectional view taken along a line Y-Y illustrated in FIG. 25A. FIG. 25D illustrates a cross-sectional view taken along a line Z-Z illustrated in FIG. 25A. FIG. 26 illustrates an enlarged plan view of a region R illustrated in FIG. 25A.

As illustrated in FIG. 25A and FIG. 26, a region R1 in which the porous semiconductor layer 3 onto which dye is adsorbed is formed, a region R3 in which the current collector terminal 7 is formed, and a region R2 between the region R1 and the region R3 are set on the transparent conductive base material 1. In the region R2, a structure 41a and a structure 41b are formed at an inner side of a region R2a in which the sealing material 6 is formed.

As illustrated in FIG. 25B, in the region R1, a plurality of stripe-shaped current collector portions 46, which are divided into parts at the center, are formed in a region in which the porous semiconductor layer 3 onto which dye is adsorbed is not formed.

As illustrated in FIGS. 25C and 26, in the region R2 between the region R1 and the region R3, the inner structure 41a having the same height as the current collector portions 46 is embedded in a concave portion between the plurality of current collector portions 46 arranged in parallel. According to this, in the region R2 between the region R1 and the region R3, a protrusion having a flat surface at the top portion is formed by parts of the plurality of current collector portions arranged in parallel and the inner structure 41a embedded between the parts of the plurality of current collector portions arranged in parallel. Further, the inner structure 41a is provided along each of a right side and a left side of the periphery at an outer side of the porous semiconductor layer 3 onto which dye is adsorbed. A rectangular frame-shaped protrusion having a flat surface at the top portion is formed by the plurality of current collector portions 46 arranged in parallel, the inner structure 41a embedded in the concave portion between the plurality of current collector portions arranged in parallel, and the inner structure 41a provided along each of the right side and the left side of the periphery. The rectangular frame-shaped protrusion is provided to surround the porous semiconductor layer 3 onto which dye is adsorbed.

As illustrated in FIGS. 25D and 26, in the region R2 between the region R1 and the region R3, an outer structure 41b having the same height as the current collector portions 46 is provided at an outer side of the inner structure 41a and is embedded in a concave portion between the plurality of current collector portions 46 arranged in parallel. According to this, in the region R2 between the region R1 and the region R3, a protrusion having a flat surface at the top portion is formed by parts of the plurality of current collector portions arranged in parallel and the outer structure 41b embedded between the parts of the plurality of current collector portions arranged in parallel. The protrusion is formed at an outer side of the inner protrusion by the inner structure 41a.

Further, the outer structure 41b is provided along the right side and the left side of the periphery at an outer side of the inner structure 41a. A rectangular frame-shaped protrusion having a flat surface at the top portion is formed by the plurality of current collector portions 46 arranged in parallel, the outer structure 41b embedded in the concave portion between the plurality of current collector portions arranged in parallel, and the outer structure 41b provided along each of the right side and the left side of the periphery. The rectangular frame-shaped protrusion is formed to surround the inner rectangular frame-shaped protrusion at an outer side of the inner rectangular frame-shaped protrusion by the inner structure 41a. That is, the porous semiconductor layer 3 onto which dye is adsorbed is double-surrounded by the inner rectangular frame-shaped protrusion and the outer rectangular frame-shaped protrusion.

(Method for Manufacturing Photoelectric Conversion Device)

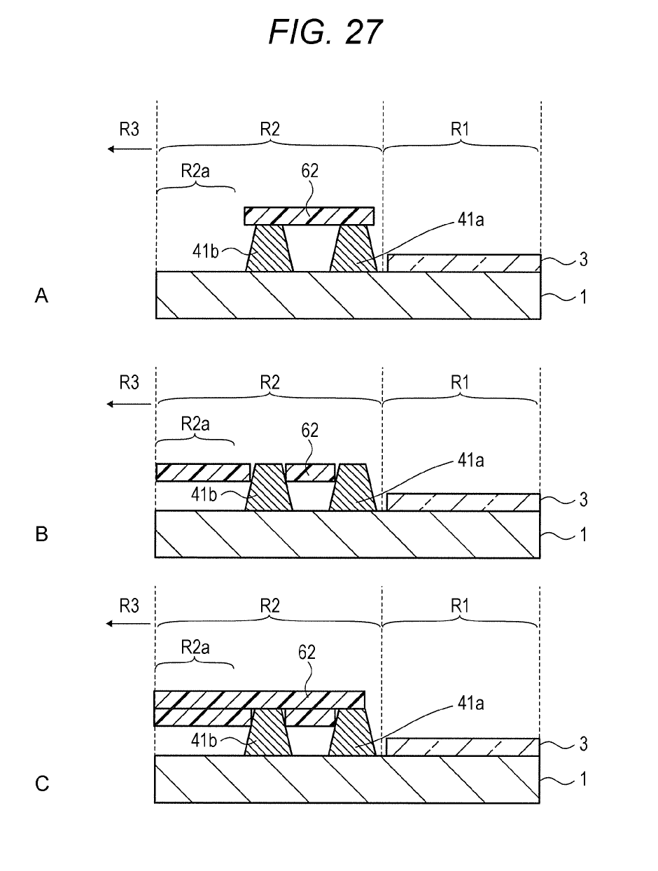

The above-described photoelectric conversion device may be manufactured in the same manner as the first embodiment. In the dye carrying process, as is the case with the first embodiment, the liquid retaining method may be used. For example, the same liquid retaining jig as the first embodiment, which is illustrated in FIGS. 5A to 5C, may be used. As illustrated in FIG. 27A, a rectangular frame-shaped packing 62 of the liquid retaining jig is brought into close contact with both of the rectangular frame-shaped protrusions which are formed by the inner structure 41a and the outer structure 41b and which double-surround the porous semiconductor layer 3 onto which dye is adsorbed, whereby a liquid retaining space that surrounds the porous semiconductor layer 3 is formed. Then, a dye solution is collected in the liquid retaining space to adsorb the dye onto the semiconductor layer 3. At this time, adhesiveness between the rectangular frame-shaped protrusions and the packing 62 becomes satisfactory, and thus liquid leakage of the dye solution that is collected in the liquid retaining space of the liquid retaining jig may be suppressed. Accordingly, dye adhesion to unnecessary sites or dye contamination on a rear surface of the transparent conductive base material 1 may be prevented, and thus utilization efficiency of a dye may be improved. In addition, contamination of a region, which is located at an outer peripheral region of the porous semiconductor layer 3 and in which a sealing material 6 is to be formed in a subsequent process, may be suppressed. In addition, as illustrated in FIG. 27B, the packing 62 may have a shape in which unevenness that fits with a concave portion between the inner structure 41a and the outer structure 41b is formed. As illustrated in FIG. 27C, the packing 62 may have a two-layer structure, and unevenness that fits with the concave portion between the inner structure 41a and the outer structure 41b may be formed in a surface layer.

### 3. THIRD EMBODIMENT

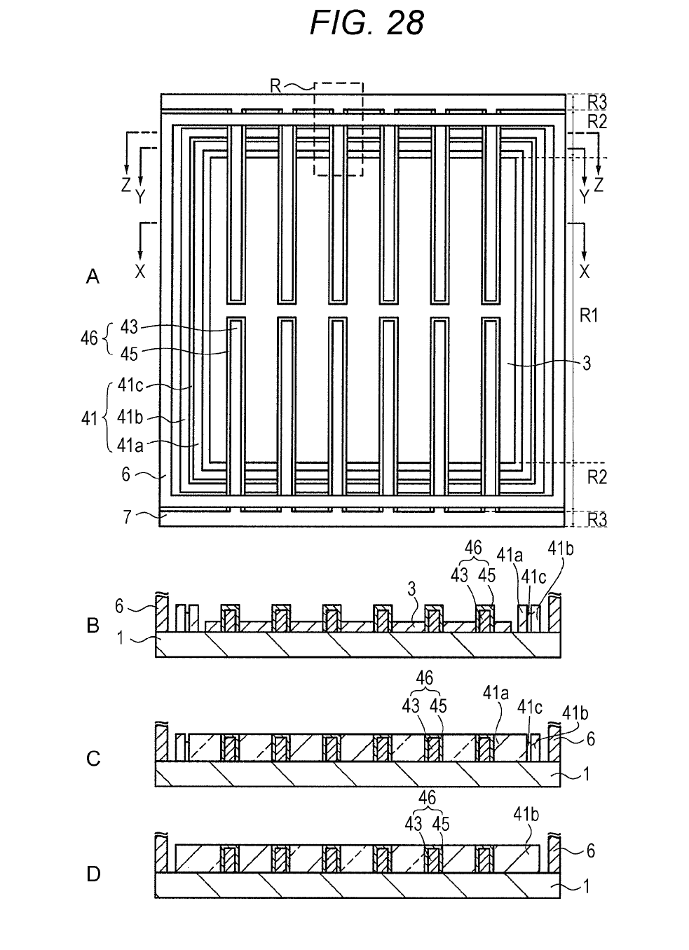

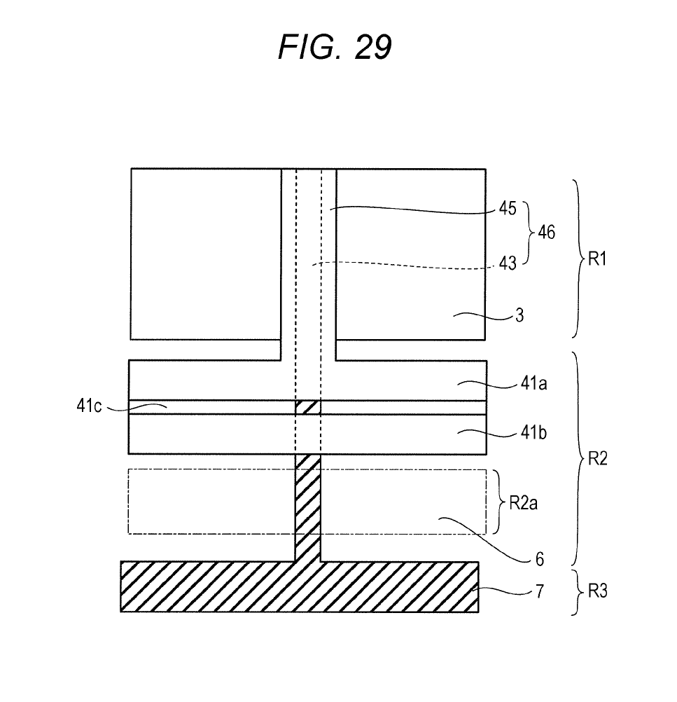

A photoelectric conversion device according to a third embodiment of the technique will be described. FIG. 28A illustrates a plan view in which a transparent conductive base material is omitted. FIG. 28B illustrates a cross-sectional view taken along a line X-X illustrated in FIG. 28A. FIG. 28C illustrates a cross-sectional view taken along a line Y-Y illustrated in FIG. 28A. FIG. 28D illustrates a cross-sectional view taken along a line Z-Z illustrated in FIG. 28A. FIG. 29 enlarges a region R illustrated in FIG. 28A.

As illustrated in FIG. 28A and FIG. 29, a region R1 in which the porous semiconductor layer 3 onto which dye is adsorbed is formed, a region R3 in which the current collector terminal 7 is formed, and a region R2 between the region R1 and the region R3 are set on the transparent conductive base material 1. In the region R2, the structure 41 is formed at an inner side of a region R2a in which the sealing material 6 is formed.

As illustrated in FIG. 28B, in the region R1, a plurality of stripe-shaped current collector portions 46, which are divided into parts at the center, are formed in a region in which the porous semiconductor layer 3 onto which dye is adsorbed is not formed.

As illustrated in FIGS. 28C and 29, in the region R2 between the region R1 and the region R3, an inner structure 41a having the same height as the current collector portions 46 is embedded in a concave portion between the plurality of current collector portions 46 arranged in parallel. According to this, in the region R2 between the region R1 and the region R3, a protrusion having a flat surface at the top portion is formed by parts of the plurality of current collector portions arranged in parallel and the inner structure 41a embedded between the parts of the plurality of current collector portions that are arranged in parallel. Further, the inner structure 41a is provided along each of a right side and a left side of the periphery at an outer side of the porous semiconductor layer 3 onto which dye is adsorbed. A rectangular frame-shaped protrusion having a flat surface at the top portion is formed by the plurality of current collector portions 46 arranged in parallel, the inner structure 41a embedded in the concave portion between the plurality of current collector portions arranged in parallel, and the inner structure 41a provided along each of the right side and the left side of the periphery. The rectangular frame-shaped protrusion is provided to surround the porous semiconductor layer 3 onto which dye is adsorbed.

As illustrated in FIGS. 28D and 29, in the region R2 between the region R1 and the region R3, an outer structure 41b having the same height as the current collector portions 46 is provided at an outer side of the inner structure 41a and is embedded in a concave portion between the plurality of current collector portions 46 arranged in parallel. According to this, in the region R2 between the region R1 and the region R3, a protrusion having a flat surface at the top portion is formed by parts of the plurality of current collector portions arranged in parallel and the outer structure 41b embedded between the parts of the plurality of current collector portions arranged in parallel. The protrusion is formed at an outer side of the inner protrusion by the inner structure 41a.

Further, the outer structure 41b is provided along the right side and the left side of the periphery at an outer side of the inner structure 41a. A rectangular frame-shaped protrusion having a flat surface at the top portion is formed by the plurality of current collector portions 46 arranged in parallel, the outer structure 41b embedded in the concave portion between the plurality of current collector portions arranged in parallel, and the outer structure 41b provided along each of the right side and the left side of the periphery. The rectangular frame-shaped protrusion is formed to surround the inner rectangular frame-shaped protrusion at an outer side of the inner rectangular frame-shaped protrusion by the inner structure 41a. That is, the porous semiconductor layer 3 onto which dye is adsorbed is double-surrounded by the inner rectangular frame-shaped protrusion and the outer rectangular frame-shaped protrusion.

As illustrated in FIGS. 28A and 29, in the region R2 between the region R1 and the region R3, an opaque structure 41c is provided between the inner structure 41a and the outer structure 41b, and is embedded in a concave portion between the plurality of current collector portions 46 arranged in parallel. Further, the opaque structure 41c is provided between the inner structure 41a and the outer structure 41b along each of the right side and the left side of the periphery. As a material that constitutes the opaque structure 41c, a material that is opaque and is colored with dye may be used. Specifically, for example, titanium oxide, zinc oxide, and tin oxide which are used for the porous semiconductor layer 3, or silver (Ag) and aluminum (Al) which are used as the material of the current collector, and the like may be used. The opaque structure 41c may be configured in one or more layers. A layer that constitutes the opaque structure 41c may be the same as the porous semiconductor layer 3.

(Method for Manufacturing Photoelectric Conversion Device)

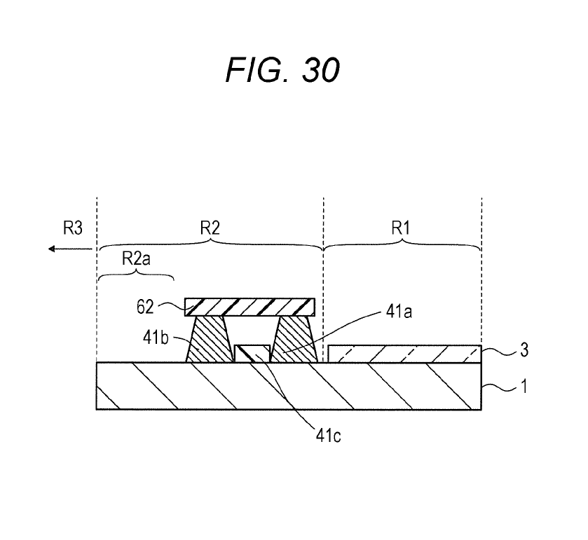

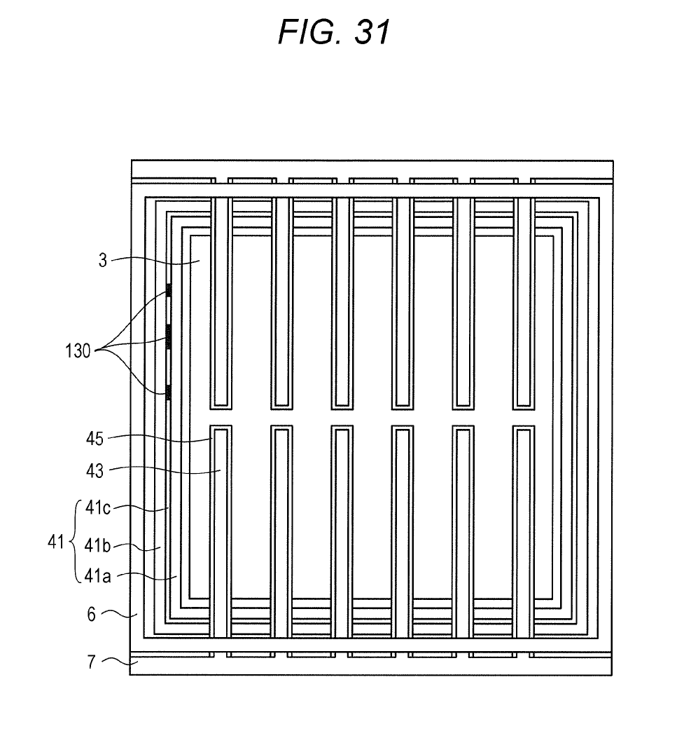

The above-described photoelectric conversion device may be manufactured in the same manner as the first embodiment. In the dye carrying process, as is the case with the first embodiment, the liquid retaining method may be used. For example, the same liquid retaining jig as the first embodiment, which is illustrated in FIGS. 5A to 5C, may be used. As illustrated in FIG. 30, a rectangular frame-shaped packing 62 of the liquid retaining jig is brought into close contact with both of the rectangular frame-shaped protrusions which are formed by the inner structure 41a and the outer structure 41b and which double-surround the porous semiconductor layer 3 onto which dye is adsorbed, whereby a liquid retaining space that surrounds the porous semiconductor layer 3 is formed. Then, a dye solution is collected in the liquid retaining space to adsorb the dye onto the semiconductor layer 3. At this time, adhesiveness between the rectangular frame-shaped protrusions and the packing 62 becomes satisfactory, and thus liquid leakage of the dye solution that is collected in the liquid retaining space of the liquid retaining jig may be suppressed. Accordingly, dye adhesion to unnecessary sites or dye contamination on a rear surface of the transparent conductive base material 1 may be prevented, and thus utilization efficiency of dye may be improved. In addition, contamination of a region which is located at an outer peripheral region of the porous semiconductor layer 3 and in which a sealing material 6 is to be formed in a subsequent process, may be suppressed. In the third embodiment, since an opaque structure 41c is provided, as illustrated in FIG. 31, in a case where the dye solution is leaked, dye contamination of the peripheral portion of the conductive base material 1, which is caused by adhesion of dye 130, is visible due to the opaque structure 41c that is constituted by the porous semiconductor layer 3. According to this, the leakage of the dye solution may be easily found, and thus inspection of a liquid leakage site becomes possible. As a result, a decrease in cell characteristics and reliability may be prevented. In addition, a liquid retaining jig which causes the liquid leakage may be specified.

### 4. FOURTH EMBODIMENT

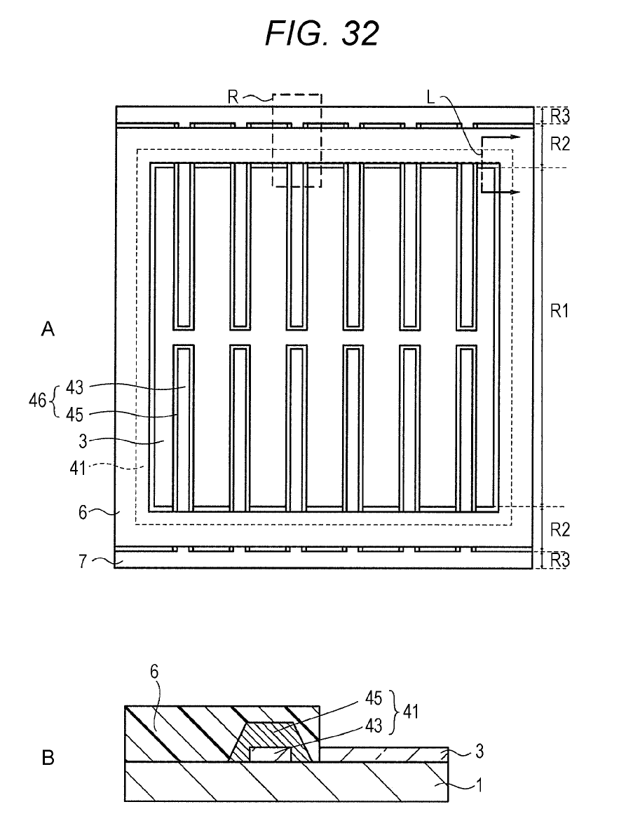

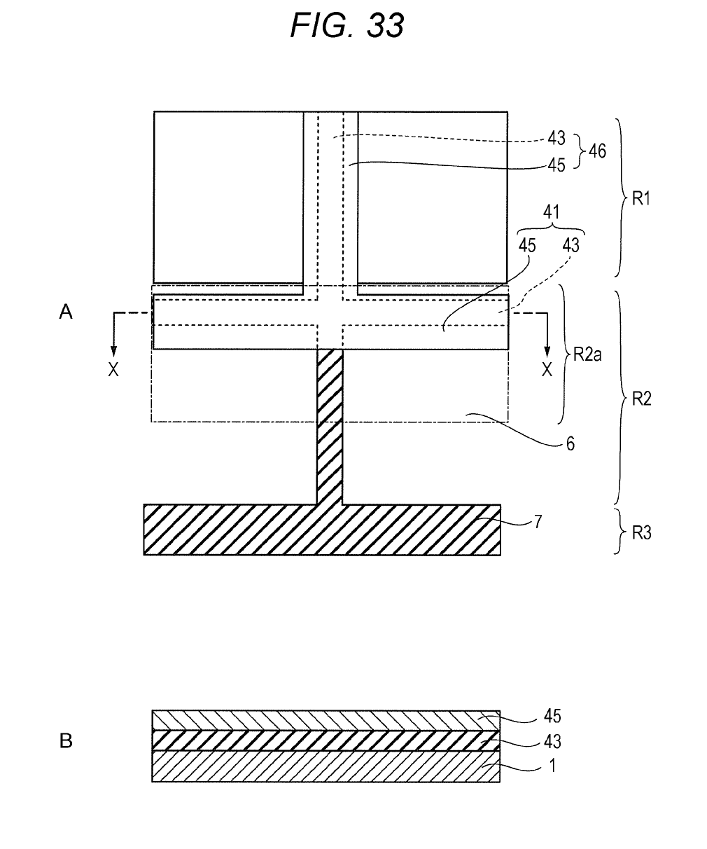

A photoelectric conversion device according to a fourth embodiment of the technique will be described. FIG. 32A illustrates a plan view in which a transparent conductive base material is omitted. FIG. 32B illustrates a cross-sectional view taken along a line L illustrated in FIG. 32A. FIG. 33A illustrates an enlarged plan view of a region R in FIG. 32A. FIG. 33B illustrates a cross-sectional view taken along a line X-X illustrated in FIG. 33A.

As illustrated in FIGS. 32A, 32B, 33A, and 33B, in a transparent conductive base material 1, a region R1 in which the porous semiconductor layer 3 onto which dye is adsorbed is formed and a region R3 in which the current collector terminal 7 is formed are set on a transparent conductive base material 1, and a region R2 is set between the region R1 and the region R3. In the region R2, a structure 41 including the current collector 43 and a protective layer 45 that covers a surface of a current collector 43 is formed in a region R2a in which a sealing material 6 is formed. The other configurations are the same as the first embodiment. In addition, the current collector 43 that constitutes the structure 41 may be substituted with the porous semiconductor layer 3.

(Method for Manufacturing Photoelectric Conversion Device)

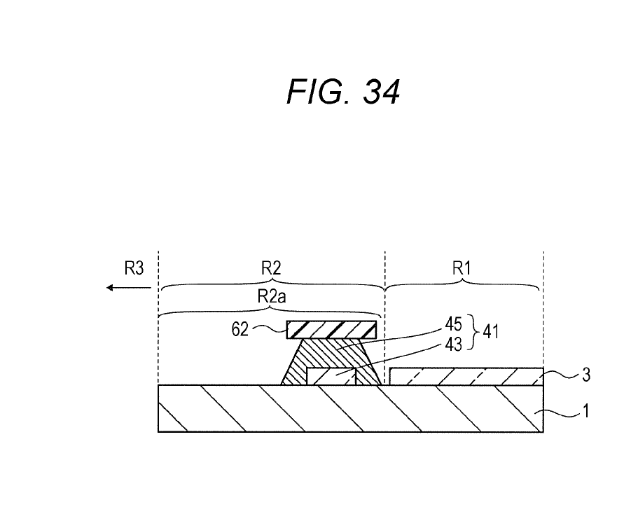

The above-described photoelectric conversion device may be manufactured in the same manner as the first embodiment. In the dye carrying process, as is the case with the first embodiment, the liquid retaining method may be used. For example, the same liquid retaining jig as the first embodiment, which is illustrated in FIGS. 5A to 5C, may be used. As illustrated in FIG. 34, the rectangular frame-shaped packing 62 of the liquid retaining jig is brought into close contact with the rectangular frame-shaped protrusion which is formed by the structure 41 and surrounds the porous semiconductor layer 3 onto which dye is adsorbed, whereby the liquid retaining space that surrounds the porous semiconductor layer 3 is formed. Then, a dye solution is collected in the liquid retaining space to adsorb the dye onto the porous semiconductor layer 3. At this time, adhesiveness between the rectangular frame-shaped protrusions and the packing 62 becomes satisfactory, and thus liquid leakage of the dye solution that is collected in the liquid retaining space of the liquid retaining jig may be suppressed. Accordingly, dye adhesion to unnecessary sites or dye contamination on a rear surface of the transparent conductive base material 1 may be prevented, and thus utilization efficiency of dye may be improved. In addition, contamination of a region R2a which is located at an outer peripheral region of the porous semiconductor layer 3 and in which a sealing material 6 is to be formed in a subsequent process, may be suppressed.

### 5. FIFTH EMBODIMENT

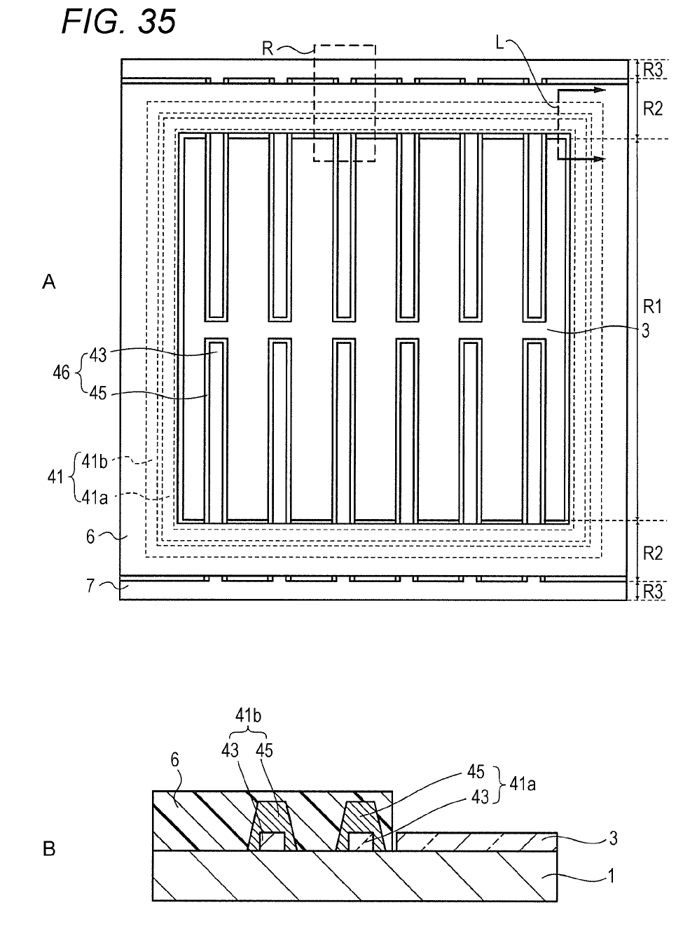

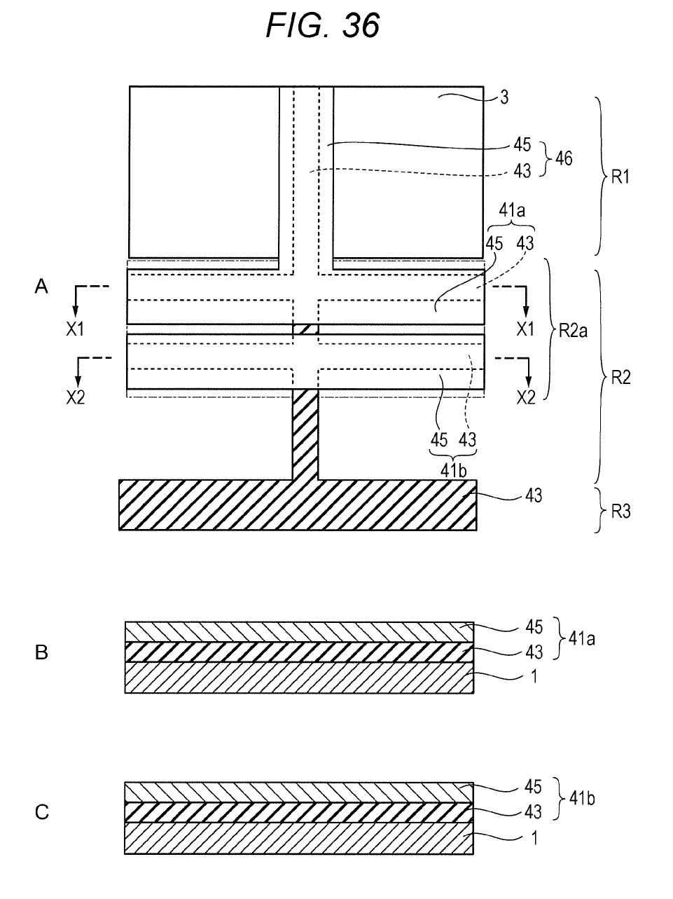

A photoelectric conversion device according to a fifth embodiment of the technique will be described. FIG. 35A illustrates a plan view in which a transparent conductive base material is omitted. FIG. 35B illustrates a cross-sectional view taken along a line L illustrated in FIG. 35A. FIG. 36A illustrates an enlarged plan view of a region R in FIG. 35A. FIG. 36B illustrates a cross-sectional view taken along a line X1-X1 illustrated in FIG. 36A. FIG. 36C illustrates a cross-sectional view taken along a line X2-X2 illustrated in FIG. 36A.

As illustrated in FIGS. 35A and 35B and FIGS. 36A, 36B and 36C, a region R1 in which the porous semiconductor layer 3 onto which dye is adsorbed is formed and a region R3 in which the current collector terminal 7 is formed are set on a transparent conductive base material 1, and a region R2 is set between the region R1 and the region R3. In the region R2, an inner structure 41a including a current collector 43 and a protective layer 45 that covers a surface of the current collector 43 is formed in a region R2a in which a sealing material 6 is formed. In the region R2, an outer structure 41b including a current collector 43 and a protective layer 45 that covers a surface of the current collector 43 is formed in the region R2a in which the sealing material 6 is formed. The other configurations are the same as the second embodiment. In addition, the current collector 43 that constitutes the structure 41 may be substituted with the porous semiconductor layer 3.

(Method for Manufacturing Photoelectric Conversion Device)

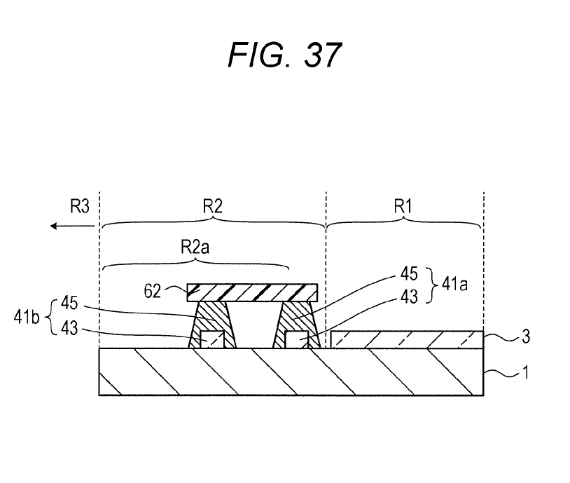

The above-described photoelectric conversion device may be manufactured in the same manner as the first embodiment. In the dye carrying process, as is the case with the first embodiment, the liquid retaining method may be used. For example, the same liquid retaining jig as the first embodiment, which is illustrated in FIGS. 5A to 5C, may be used. As illustrated in FIG. 37, a rectangular frame-shaped packing 62 of the liquid retaining jig is brought into close contact with both of the rectangular frame-shaped protrusions which are formed by the inner structure 41a and the outer structure 41b and which double-surround the porous semiconductor layer 3 onto which dye is adsorbed, whereby a liquid retaining space that surrounds the porous semiconductor layer 3 is formed. Then, a dye solution is collected in the liquid retaining space to adsorb the dye onto the porous semiconductor layer 3. At this time, adhesiveness between the rectangular frame-shaped protrusions and the packing 62 becomes satisfactory, and thus liquid leakage of the dye solution that is collected in the liquid retaining space of the liquid retaining jig may be suppressed. Accordingly, dye adhesion to unnecessary sites or dye contamination on a rear surface of the transparent conductive base material 1 may be prevented, and thus utilization efficiency of dye may be improved. In addition, contamination of a region, which is located at an outer peripheral region of the porous semiconductor layer 3 and in which a sealing material 6 is to be formed in a subsequent process, may be suppressed.

### 6. SIXTH EMBODIMENT

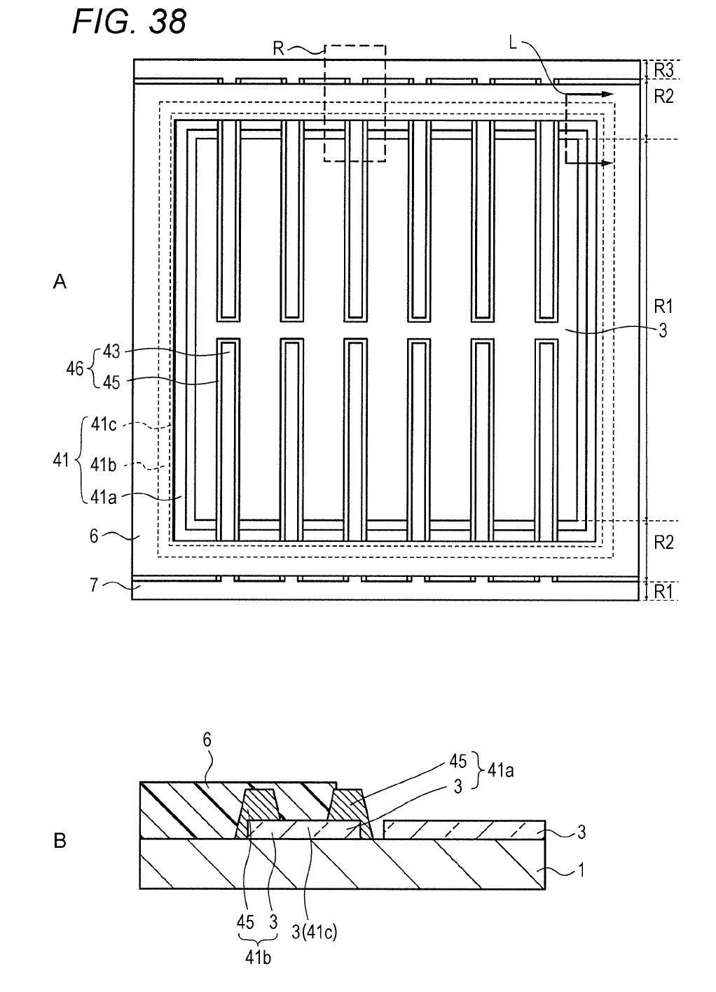

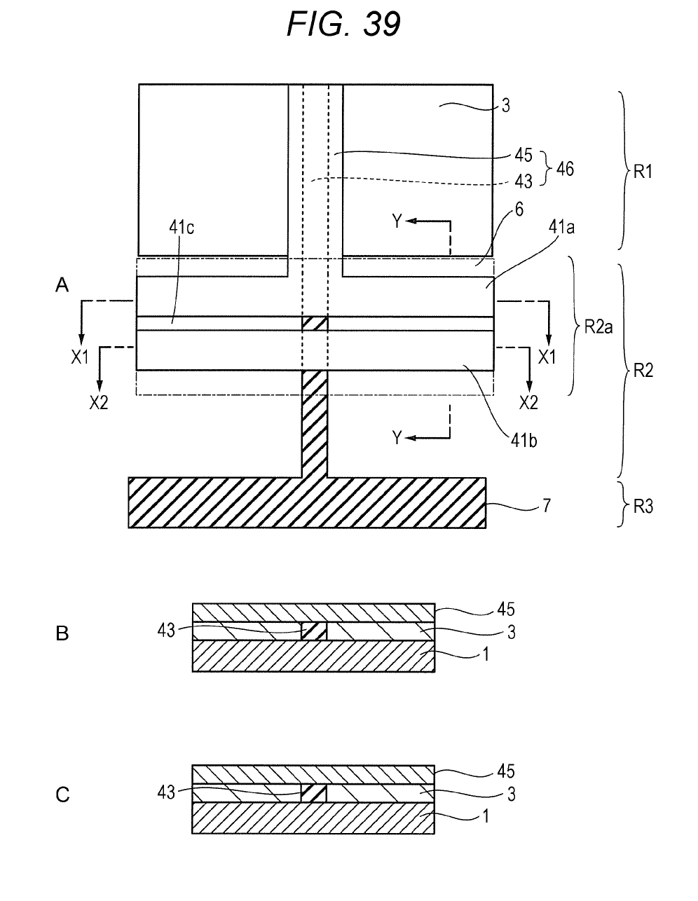

A photoelectric conversion device according to a sixth embodiment of the technique will be described. FIG. 38A illustrates a plan view in which a transparent conductive base material is omitted. FIG. 38B illustrates a cross-sectional view taken along a line L illustrated in FIG. 38A. FIG. 39A illustrates an enlarged plan view of a region R in FIG. 38A. FIG. 39B illustrates a cross-sectional view taken along a line X1-X1 illustrated in FIG. 39A. FIG. 39C illustrates a cross-sectional view taken along a line X2-X2 illustrated in FIG. 39A.

As illustrated in FIGS. 38A and 38B and FIGS. 39A, 39B and FIG. 39C, a region R1 in which the porous semiconductor layer 3 onto which dye is adsorbed is formed and a region R3 in which the current collector terminal 7 is formed are set on a transparent conductive base material 1, and a region R2 is set between the region R1 and the region R3. In the region R2, an inner structure 41a including a porous semiconductor layer 3 and a protective layer 45 that covers a surface of the porous semiconductor layer 3 is formed in a region R2a in which a sealing material 6 is formed. In the region R2, a structure 41b including a porous semiconductor layer 3 and a protective layer 45 that covers a surface of the porous semiconductor layer 3 is formed in the region R2a in which the sealing material 6 is formed. In the region R2, an opaque structure 41c that is constituted by the porous semiconductor layer 3 is formed in the region R2a in which the sealing material 6 is formed. The other configurations are the same as the third embodiment. In addition, the porous semiconductor layer 3 that constitutes the structure 41a and the structure 41b may be substituted with the current collector 43.

(Method for Manufacturing Photoelectric Conversion Device)

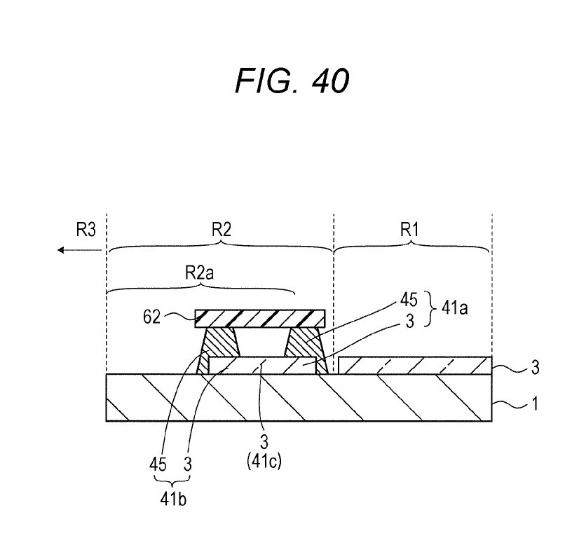

The above-described photoelectric conversion device may be manufactured in the same manner as the first embodiment. In the dye carrying process, as is the case with the first embodiment, the liquid retaining method may be used. For example, the same liquid retaining jig as the first embodiment, which is illustrated in FIGS. 5A to 5C, may be used. As illustrated in FIG. 40, a rectangular frame-shaped packing 62 of the liquid retaining jig is brought into close contact with both of the rectangular frame-shaped protrusions which are formed by the inner structure 41a and the outer structure 41b and which double-surround the porous semiconductor layer 3 onto which dye is adsorbed, whereby a liquid retaining space that surrounds the porous semiconductor layer 3 is formed. Then, a dye solution is collected in the liquid retaining space to adsorb the dye onto the porous semiconductor layer 3. At this time, adhesiveness between the rectangular frame-shaped protrusions and the packing 62 becomes satisfactory, and thus liquid leakage of the dye solution that is collected in the liquid retaining space of the liquid retaining jig may be suppressed. Accordingly, dye adhesion to unnecessary sites or dye contamination on a rear surface of the transparent conductive base material 1 may be prevented, and thus utilization efficiency of dye may be improved. In addition, contamination of a region, which is located at an outer peripheral region of the porous semiconductor layer 3 and in which a sealing material 6 is to be formed in a subsequent process, may be suppressed. In addition, in the sixth embodiment, since an opaque structure 41c constituted by the porous semiconductor layer 3 is provided, in a case where the dye solution is leaked, dye contamination of the peripheral portion of the transparent conductive base material 1, which is caused by adhesion of dye, is visible due to the opaque structure 41c that is constituted by the porous semiconductor layer 3. According to this, the leakage of the dye solution may be easily found, and thus inspection of a liquid leakage site becomes possible. As a result, a decrease in cell characteristics and reliability may be prevented. In addition, a liquid retaining jig which causes the liquid leakage may be specified.

### 7. SEVENTH EMBODIMENT

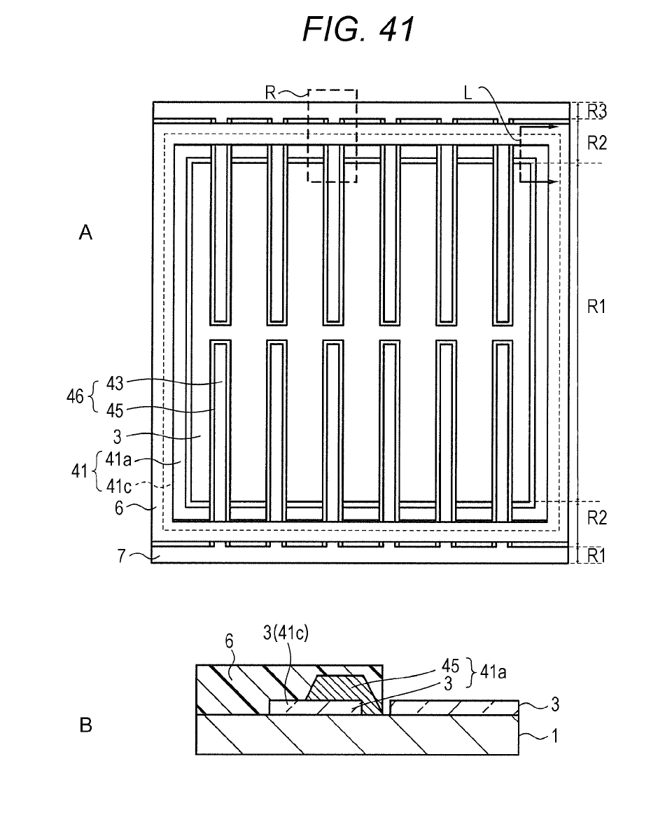

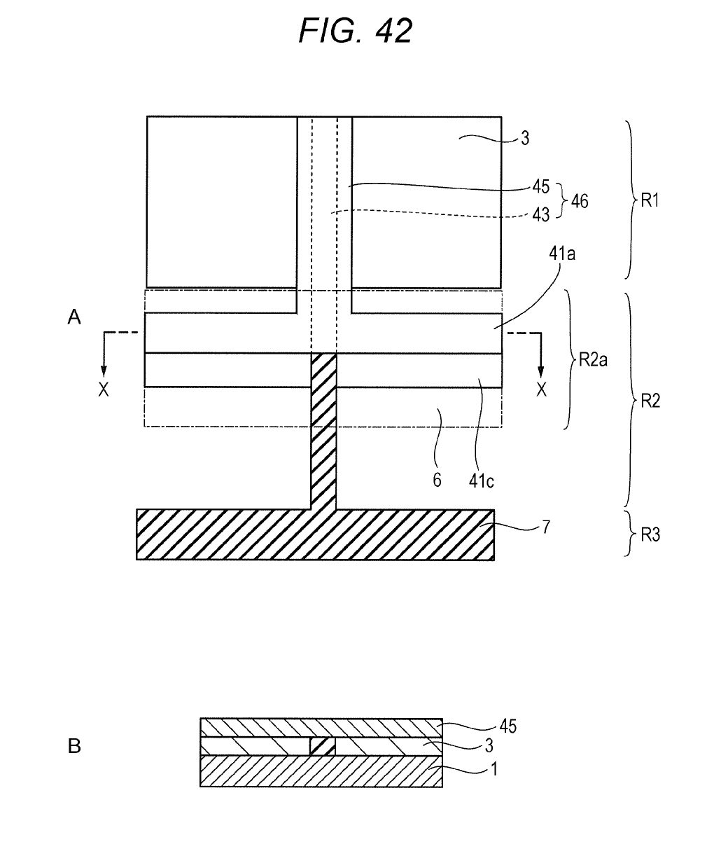

A photoelectric conversion device according to a seventh embodiment of the technique will be described. FIG. 41A illustrates a plan view in which a transparent conductive base material is omitted. FIG. 41B illustrates a cross-sectional view taken along a line L illustrated in FIG. 41A. FIG. 42A illustrates an enlarged plan view of a region R of FIG. 41A. FIG. 42B illustrates a cross-sectional view taken along a line L illustrated in FIG. 42A.

As illustrated in FIGS. 41A and 42A, a region R1 in which the porous semiconductor layer 3 onto which dye is adsorbed is formed, a region R3 in which the current collector terminal 7 is formed, and a region R2 between the region R1 and the region R3 are set on the transparent conductive base material 1. In the region R2, a structure 41 is formed in a region R2a in which a sealing material 6 is formed.

As illustrated in FIG. 41B, in the region R1, a plurality of stripe-shaped current collector portions 46, which are divided into parts at the center, are formed in a region in which the porous semiconductor layer 3 onto which dye is adsorbed is not formed.

As illustrated in FIG. 41c, in the region R2 between the region R1 and the region R3, the inner structure 41a having the same height as the current collector portions 46 is embedded in a concave portion between the plurality of current collector portions 46 arranged in parallel. According to this, in the region R2 between the region R1 and the region R3, a protrusion having a flat surface at the top portion is formed by parts of the plurality of current collector portions arranged in parallel and the inner structure 41a embedded between the parts of the plurality of current collector portions arranged in parallel. Further, the inner structure 41a is provided along each of a right side and a left side of the periphery at an outer side of the porous semiconductor layer 3 onto which dye is adsorbed. A rectangular frame-shaped protrusion having a flat surface at the top portion is formed by the plurality of current collector portions 46 arranged in parallel, the inner structure 41a embedded in the concave portion between the plurality of current collector portions arranged in parallel, and the inner structure 41a provided along each of the right side and the left side of the periphery. The rectangular frame-shaped protrusion is provided to surround the porous semiconductor layer 3 onto which dye is adsorbed.

As illustrated in FIGS. 41A and 42A, in the region R2 between the region R1 and the region R3, an opaque structure 41c is provided at an outer side of the inner structure 41a, and is embedded in a concave portion between the plurality of current collector portions 46 arranged in parallel. Further, the opaque structure 41c is provided at an outer side of the inner structure 41a along each of a right side and a left side of the periphery. The opaque structure 41c may be constituted by the porous semiconductor layer 3.

(Method for Manufacturing Photoelectric Conversion Device)

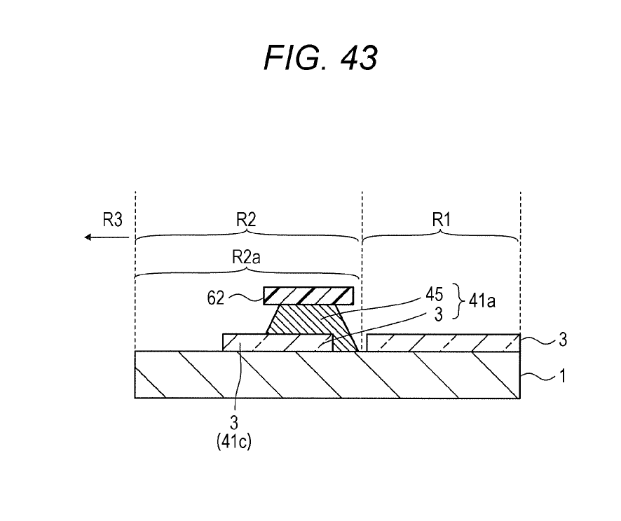

The above-described photoelectric conversion device may be manufactured in the same manner as the first embodiment. In the dye carrying process, as is the case with the first embodiment, the liquid retaining method may be used. For example, the same liquid retaining jig as the first embodiment, which is illustrated in FIGS. 5A to 5C, may be used. As illustrated in FIG. 43, a rectangular frame-shaped packing 62 of the liquid retaining jig is brought into close contact with both of the rectangular frame-shaped protrusions which are formed by the inner structure 41a and which surround the porous semiconductor layer 3 onto which dye is adsorbed, whereby a liquid retaining space that surrounds the porous semiconductor layer 3 is formed. Then, a dye solution is collected in the liquid retaining space to adsorb the dye onto the porous semiconductor layer 3. At this time, adhesiveness between the rectangular frame-shaped protrusions and the packing 62 becomes satisfactory, and thus liquid leakage of the dye solution that is collected in the liquid retaining space of the liquid retaining jig may be suppressed. Accordingly, dye adhesion to unnecessary sites or dye contamination on a rear surface of the transparent conductive base material 1 may be prevented, and thus utilization efficiency of dye may be improved. In addition, contamination of a region, which is located at an outer peripheral region of the porous semiconductor layer 3 and in which a sealing material 6 is to be formed in a subsequent process, may be suppressed. In addition, in the seventh embodiment, since the opaque structure 41c is provided, in a case where a dye solution is leaked, dye contamination of the peripheral portion of the transparent conductive base material 1, which is caused by adhesion of dye, is visible due to the opaque structure 41c that is constituted by the porous semiconductor layer 3. According to this, the leakage of the dye solution may be easily found, and thus inspection of a liquid leakage site becomes possible. As a result, a decrease in cell characteristics and reliability may be prevented. In addition, a liquid retaining jig which causes the liquid leakage may be specified.

### EXAMPLES

Specific examples of the technique will be described. The technique is not limited thereto.

### Example 1

A porous titanium oxide layer as the porous semiconductor layer 3 was prepared using a FTO substrate as the transparent conductive base material 1, and a ruthenium-based dye was used as the dye to be adsorbed onto the porous titanium oxide layer, whereby a photoelectric conversion device was prepared.

(Preparation of Dye-Adsorbed Body)

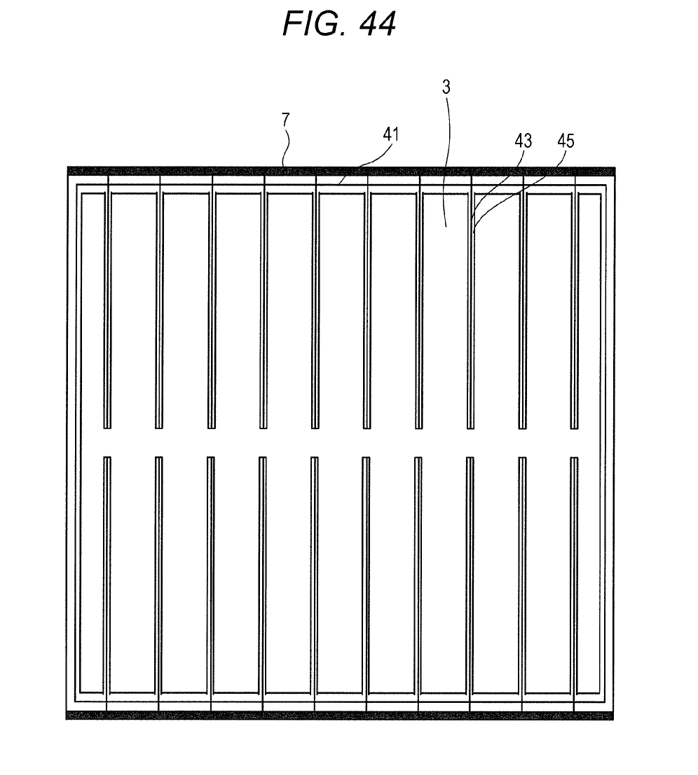

First, the dye-adsorbed body W illustrated in FIG. 44 was prepared. As the transparent conductive base material 1, a base material, in which the transparent conductive layer 12 constituted by the FTO layer was formed on a glass substrate as the base material 11, was used.

Next, a porous titanium oxide layer as the porous semiconductor layer 3 was formed on the transparent conductive layer 12. Specifically, TiO₂ paste was prepared, and the paste was applied onto the transparent conductive layer 12 to obtain the porous semiconductor layer 3 having a shape illustrated in FIG. 44. In addition, the porous titanium oxide layer was baked in an electric furnace at 510° C. for 30 minutes and was cooled in the electric furnace. Next, the current collector 43 and the current collector terminal 7 which were formed from Ag were formed on the transparent conductive layer 12. Specifically, silver paste was applied onto the transparent conductive layer 12 by a screen printing method to obtain the current collector 43 and the current collector terminal 7 which have a shape illustrated in FIG. 44. In addition, after the applied silver paste was sufficiently dried, baking was carried out in an electric furnace at 510° C. for 30 minutes. Next, the protective layer 45 was formed to shield and protect the current collector 43 from an electrolytic solution. Specifically, an epoxy-based resin was applied using the screen printing method to form the protective layer, thereby forming the protective layer 45 having a shape illustrated in FIG. 44. After leveling of the epoxy-based resin was sufficiently carried out, the epoxy-based resin was completely cured by using an UV spot irradiation device. In addition, during the application of the silver paste, the silver paste was also applied onto a region in which the structure 41 is to be provided, and then the subsequent drying and baking were carried out as described above. In addition, during application of the epoxy-based resin, the epoxy-based resin was also applied onto a region in which the structure 41 is to be provided, and then the subsequent curing of the epoxy-based resin was carried out as described above, whereby the structure 41 having a shape illustrated in FIG. 44, in which a silver surface was covered with the epoxy-based resin, was formed.

(Dye Adsorption by Liquid Retaining Method)

Dye was allowed to be adsorbed onto the TiO₂ layer as the porous semiconductor layer 3 according to the liquid retaining method. That is, the dye-adsorbed body W was set in the liquid retaining jig illustrated in FIG. 5, a dye solution (10 mM) formed from dimethyl sulfoxide in which a ruthenium-based dye was dissolved was injected into the liquid retaining jig, whereby the dye solution was collected in the liquid retaining space as illustrated in FIG. 6. At this time, the rectangular frame-shaped packing 62 was brought into close contact with the rectangular frame-shaped protrusion formed by the structure 41. Then, retention was carried out for a predetermined time. In addition, at this time, a used amount of the dye solution was 5 ml.

(Rinsing Treatment)

Next, after draining the dye solution inside the liquid retaining jig, the rinse treatment was carried out in a state in which the dye-adsorbed body W was disposed in and fixed to the liquid retaining jig. Specifically, injection and drainage of the rinse liquid were repeated three times with respect to the liquid retaining jig. Then, the porous semiconductor layer 3 onto which the dye was adsorbed was dried with an air blow. As the rinse liquid, acetonitrile was used.

On the other hand, a glass plate was used as the base material 21, and a Pt layer as the counter electrode 5 was formed on the base material 21. Specifically, a Pt layer was formed on the glass plate by sputtering.

Next, a predetermined position of the base material 21 was irradiated with YAG laser to provide an injection port. Then, the sealing material 6 was formed in a shape illustrated in FIG. 1. Next, an electrolytic solution was prepared. The electrolytic solution was prepared as follows. 0.045 g of sodium iodide, 1.11 g of 1-propyl-2,3-dimethylimidazolium iodide, 0.11 g of iodine, and 0.081 g of 4-tert-butylpyridine were dissolved in 3.0 g of methoxypropionitrile, thereby preparing the electrolytic solution. Next, the electrolytic solution was injected from the injection port provided to the base material 21, and retention was carried out for a predetermined time to allow the electrolytic solution to completely penetrate between the transparent conductive base material 1 and the base material 21 on which the Pt layer was formed. Then, the electrolytic solution at the periphery of the injection port was completely removed, and the injection port was sealed with an ultraviolet curable resin. In this manner, the photoelectric conversion device was prepared.

### COMPARATIVE EXAMPLE 1

A dye-adsorbed body W illustrated in FIG. 44 was prepared in the same manner as Example 1.

(Dye Adsorption by Immersion Method)

Dye was allowed to be adsorbed onto the porous titanium oxide layer as the porous semiconductor layer 3 according to an immersion method. That is, the entirety of dye-adsorbed body W was immersed in a mixed solution (0.2 mM) of tert-butanol/acetonitrile in which the ruthenium-based dye was dissolved for 24 hours to adsorb the dye onto the porous semiconductor layer 3. In addition, at this time, a used amount of the dye solution was 500 ml.

Next, the porous semiconductor layer 3 was rinsed with acetonitrile and was dried. Then, dye adhered to a region in which a sealing member is to be formed was removed using dimethyl sulfoxide and was rinsed again with acetonitrile and was dried. The subsequent processes were the same as Example 1. In this manner, the photoelectric conversion device was prepared.

The following evaluation was carried out with respect to Example 1 and Comparative Example 1.

(Evaluation of Dye Adsorption Time)

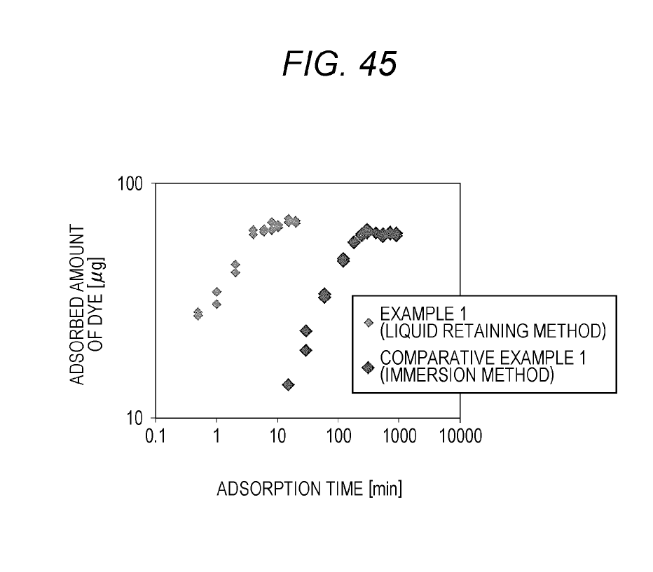

Evaluation of dye adsorption time was carried out by measuring a dye adsorption amount against an adsorption time. The dye adsorption amount was measured by visible and ultraviolet spectroscopy. A graph in which the dye adsorption amount against the adsorption time is plotted is illustrated in FIG. 45.

(85° C. Reliability Evaluation)

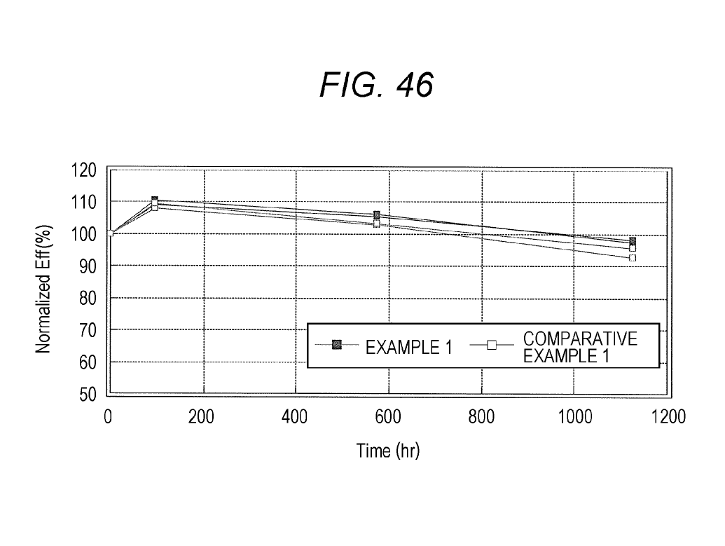

85° C. reliability evaluation was carried out to measure a rate of change of standardized Eff (%) against an elapsed time under an environment of a temperature of 85° C. Measured results are illustrated in FIG. 46. In addition, the evaluation was carried out with respect to Example 1 and Comparative Example 1 for two samples, respectively.

As illustrated in FIG. 45, in Example 1, the dye adsorption time according to the liquid retaining method was shortened compared to the immersion method of Comparative Example 1. As illustrated in FIG. 46, it was confirmed that in Example 1, the same cell characteristics and reliability as Comparative Example 1 were obtained.

### Example 2-1

A dye-adsorbed body W illustrated in FIG. 44 was prepared in the same manner as Example 1.

(Dye Adsorption by Liquid Retaining Method)

Dye was allowed to be adsorbed onto a porous titanium oxide layer as the porous semiconductor layer 3 according to the liquid retaining method. That is, the dye-adsorbed body W was disposed in and fixed to the liquid retaining jig illustrated in FIG. 5, a dye solution (10 mM) formed from dimethyl sulfoxide in which a ruthenium-based dye was dissolved was injected into the liquid retaining jig, whereby the dye solution was collected in the liquid retaining space as illustrated in FIG. 6. At this time, the rectangular frame-shaped packing 62 was brought into close contact with the rectangular frame-shaped protrusion formed by the structure 41. Then, retention was carried out for a predetermined time (approximately 20 minutes). In addition, at this time, a used amount of the dye solution was 5 ml.

(Rinsing Treatment)

Next, after draining the dye solution inside the liquid retaining jig, the rinse treatment was carried out in a state in which the dye-adsorbed body W was disposed in and fixed to the liquid retaining jig. Specifically, injection and drainage of the rinse liquid were repeated three times with respect to the liquid retaining jig. Then, the porous semiconductor layer 3 onto which the dye was adsorbed was dried with an air blow. As the rinse liquid, the same rinse liquid as Example 1 was used.

The subsequent processes were carried out in the same manner as Example 1, whereby a photoelectric conversion device was obtained.

### Example 2-2

A rinsing process was carried out in a state in which the dye-adsorbed body was detached from the liquid retaining jig. The other configurations were the same as Example 2-1, whereby a photoelectric conversion device was obtained.

### COMPARATIVE EXAMPLE 2

The dye-adsorbed body W illustrated in FIG. 44 was prepared in the same manner as Example 2-1.

(Dye Adsorption by Immersion Method)

A dye was allowed to be adsorbed onto the porous titanium oxide layer as the porous semiconductor layer 3 according to an immersion method. That is, the entirety of dye-adsorbed body W was immersed in a mixed solution (0.2 mM) of tert-butanol/acetonitrile in which the ruthenium-based dye was dissolved for approximately 40 hours to adsorb dye onto the porous semiconductor layer 3. In addition, at this time, a used amount of the dye solution was 500 ml.

Next, the porous semiconductor layer 3 was rinsed with acetonitrile and was dried. At this time, a region in which the sealing member is to be formed was not subjected to the washing treatment. The subsequent processes were carried out in the same manner as Example 1. In this manner, a photoelectric conversion device was prepared.

(85° C. Reliability Evaluation)

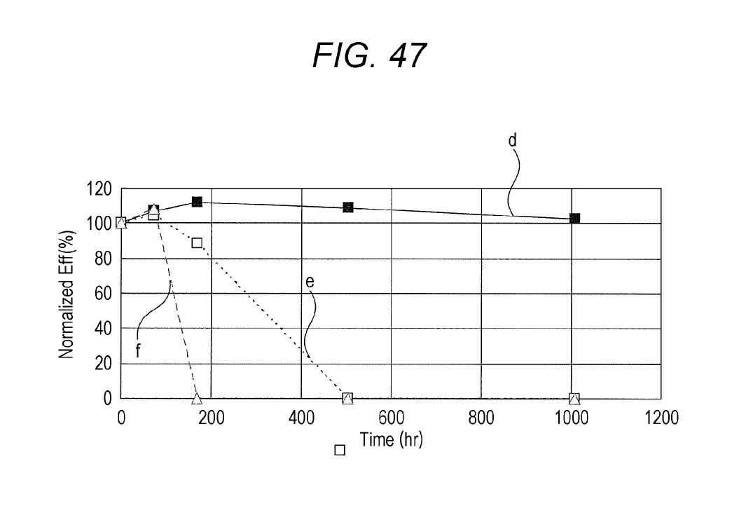

With respect to Example 2-1 and 2-2, and Comparative Example 2, 85° C. reliability evaluation was carried out to measure a rate of change of standardized Eff (%) against an elapsed time under an environment of a temperature of 85° C. Measured results are illustrated in FIG. 47. In addition, in FIG. 47, a line d is a graph illustrating the measured results with respect to Example 2-1, a line e is a graph illustrating the measured results with respect to Example 2-2, and a line f is a graph illustrating the measured results with respect to Comparative Example 2.

In Example 2-1, since the liquid retaining jig was used in both of the dye adsorption process and the rinsing process, dye adhesion to the sealing member forming region did not occur, and reliability under the environment of a temperature of 85° C. was satisfactory as indicated by the line d. In Example 2-2, since the liquid retaining jig was not used in the rinsing process, dye adhesion to the sealing member forming region occurred, and thus as indicated by the line e, reliability under the environment of a temperature of 85° C. deteriorated. On the other hand, in Comparative Example 2, since the liquid retaining jig was not used in the dye adsorption process and the rinsing process, a large amount of dye was adhered to the sealing member forming region, and thus this became a cause of leakage of the electrolytic solution. Therefore, as indicated by the line f, reliability under the environment of a temperature of 85° C. significantly deteriorated.

### 8. OTHER EMBODIMENTS

The technique is not limited to the above-described embodiments, and various modifications and applications may be made within a range not departing from the gist of the technique.

For example, the configurations, methods, processes, shapes, materials, dimensions, and the like, which are exemplified in the above-described embodiments and examples are illustrative only, and according to necessity, different configurations, methods, processes, shapes, materials, dimensions, and the like may be used.

In addition, the configurations, methods, processes, shapes, materials, dimensions, and the like of the above-described embodiments may be combined to each to each other in a range not departing from the gist of the technique.

In the rectangular frame-shaped protrusion having a flat surface at the top portion, the flat surface may be an approximately flat surface. Here, the approximately flat surface represents a surface in which the depth of a concave portion or the height of a convex portion is 100 μm or less.

In the example illustrated in FIG. 25A, description has been made with respect to an example in which the porous semiconductor layer 3 is double-surrounded by rectangular frame-shaped protrusions having a flat surface at the top portion. However, the porous semiconductor layer 3 may be surrounded by rectangular frame-shaped protrusions having a flat surface at the top portion in three or more folds.

In addition, the plurality of current collector portions 46 may have a stripe shape that is not divided into parts at the center, and may have a lattice shape.

In addition, a module may be formed by combining a plurality of the photoelectric conversion device (cell) according to the above-described embodiments. The plurality of photoelectric conversion devices may be electrically connected in series and/or in parallel, and for example, in a case of combining the photoelectric conversion devices in series, a high power generation voltage may be obtained.

In addition, the technique may have the following configurations.

[1-1] A photoelectric conversion device, including:

a conductive base material;

a porous semiconductor layer which is disposed on the conductive base material and onto which dye is adsorbed;

a counter electrode;

an electrolyte layer;

a sealing material that is formed at the periphery of the conductive base material; and

at least one protrusion formed between the porous semiconductor layer and an outer periphery of the sealing material.

[1-2] The photoelectric conversion device according to [1-1],

wherein the protrusion is provided to surround the porous semiconductor layer.

[1-3] The photoelectric conversion device according to any of [1-1] to [1-2], further including:

a plurality of current collector portions provided on the conductive base material,

wherein the protrusion has a plurality of structures that are provided between the plurality of current collector portions.

[1-4] The photoelectric conversion device according to [1-3],

wherein the structure has the same height or substantially the same height as a height of the current collector portions.

[1-5] The photoelectric conversion device according to any of [1-3] to [1-4],

wherein a difference in the height between the structure and the current collector portions is 100 μm or less.

[1-6] The photoelectric conversion device according to any of [1-3] to [1-5],

wherein the structure is a structure that suppresses leakage of a dye solution by close contact of an elastic body.

[1-7] The photoelectric conversion device according to any of [1-3] to [1-6],

wherein a current collector terminal that is connected to the current collector portions is provided at the peripheral portion, and

the sealing material is provided between the current collector terminal and the porous semiconductor layer.

[1-8] The photoelectric conversion device according to any of [1-3] to [1-7],

wherein each of the current collector portions includes a current collector layer and a protective layer that covers the current collector layer.

[1-9] The photoelectric conversion device according to [1-8],

wherein the structure has one or more layers, and

the layers are formed of at least any material of the current collector layer, the porous semiconductor layer, and the protective layer.

[1-10] The photoelectric conversion device according to any of [1-1] to [1-9],

wherein the protrusion has a flat surface or a substantially flat surface at a top portion.

[1-11] The photoelectric conversion device according to any of [1-1] to [1-10],

wherein an opaque structure containing an opaque material as a main component is provided at an external side of the protrusion.

[1-12] The photoelectric conversion device according to [1-11], in which the opaque material is a material that adsorbs dye.

[1-13] A method for manufacturing a photoelectric conversion device, including:

forming a porous semiconductor layer on a conductive base material;

forming one or more protrusions between an outer periphery of a sealing material formed at the periphery of the conductive base material, and the porous semiconductor layer to surround the porous semiconductor layer; and

bringing an elastic body into close contact with the protrusion to form a liquid retaining space that surrounds the porous semiconductor layer, retaining a dye solution in the liquid retaining space, and allowing the porous semiconductor layer to adsorb dye.

Furthermore, the technique may have the following configurations.

[2-1] A dye adsorption device, including:

a dye solution supply unit; and

a dye solution adsorption unit,

wherein the dye solution adsorption unit includes a liquid retaining jig having a base body on which a photoelectrode base material for a photoelectric conversion element is mounted, and a cover body that forms a liquid retaining space on a surface of the photoelectrode base material, and

the cover body has an elastic member that presses a peripheral portion of a dye adsorption region of the photoelectrode base material mounted on the base body.

[2-2] The dye adsorption device according to [2-1], further including:

a dye solution recovery unit that recovers a dye solution collected in the liquid retaining space.

[2-3] The dye adsorption device according to [2-2], further including:

a dye solution adjusting unit that adjusts the dye solution recovered by the dye solution recovery unit and supplies the adjusted dye solution to the dye solution supply unit.

[2-4] The dye adsorption device according to any one of [2-1] to [2-3], further including: a drive unit that carries out at least one operation of inclination, fluctuation, vibration, and rotation with respect to the liquid retaining jig in which the liquid retaining space is formed on a surface of the photoelectrode base material.

[2-5] The dye adsorption device according to any of [2-1] to [2-4], further including:

a rinse liquid supply unit that supplies a rinse liquid to the liquid retaining space; and

a rinse liquid recovery unit that recovers the rinse liquid collected in the liquid retaining space,

wherein the rinse liquid supply unit and the rinse liquid recovery unit carry out a rinse treatment process from supply of the rinse liquid to recovery of the rinse liquid n (n: natural number) or more times with respect to the same photoelectrode base material.

[2-6] The dye adsorption device according to [2-5], in which in an n^{th} rinse treatment process, the rinse liquid supply unit and the rinse liquid recovery unit carry out rinse treatment using a rinse liquid recovered at n+1^{th} or later rinse treatment.

[2-7] The dye adsorption device according to any one of [2-1] to [2-6], further including:

a photoelectrode base material detaching unit that detaches the photoelectrode base material from the liquid retaining jig after the rinsing process; and

a liquid retaining jig washing unit that washes the liquid retaining jig from which the photoelectrode base material is detached,

in which a photoelectrode base material is mounted again on the liquid retaining jig washed by the liquid retaining jig washing unit.

[2-8] The dye adsorption device according to any one of [2-1] to [2-7],

in which the photoelectrode base material includes a conductive base material having a surface and a porous semiconductor layer formed on the surface, and

the dye adsorption region is a region in which a porous semiconductor layer onto which dye is to be adsorbed is formed.

[2-9] The dye adsorption device according to any one of [2-1] to [2-8], further including:

one or more current collector portions that extend to at least apart of a peripheral portion of the porous semiconductor layer from the porous semiconductor layer,

in which an uneven shape is formed at least at a part of the peripheral portion by the current collector portions, and

the elastic member has an uneven shape conforming to the uneven shape of the current collector portions.

[2-10] The dye adsorption device according to any of [2-1] to [2-9],

wherein the peripheral portion includes a region for forming a sealing portion of the photoelectrode base material, and

the elastic member covers at least a part of the region for forming the sealing portion of the photoelectrode base material mounted on the base body, and a region between the dye adsorption region and the region for forming the sealing portion.

[2-11] The dye adsorption device according to any one of [2-1] to [2-10],

in which an uneven portion is formed at the peripheral portion, and

the elastic member has an uneven shape conforming to the uneven portion.

[2-12] The dye adsorption device according to any one of [2-1] to [2-11],

in which the base body has a concave portion at which the photoelectrode base material for a photoelectric conversion element is disposed, and

the concave portion has a bottom surface in which a hole or an opening is provided.

[2-13] The dye adsorption device according to any one of [2-1] to [2-12],

in which the cover body has a frame-shaped body having an opening, and

the opening is provided at a position corresponding to the dye adsorption region in a state in which the cover body is disposed on a surface of the photoelectrode base material mounted on the base body.

[2-14] The dye adsorption device according to [2-13],

in which the opening forms the liquid retaining space in a state in which the cover body is disposed on a surface of the photoelectrode base material mounted on the base body.

[2-15] The dye adsorption device according to [2-13],

in which the frame-shaped body includes a plurality of the openings, and

the plurality of openings are provided at positions corresponding a plurality of the dye adsorption regions in a state in which the cover body is disposed on a surface of the photoelectrode base material mounted on the base body.

[2-16] The dye adsorption device according to any one of [2-1] to [2-15],

in which the cover body is a cover unit that covers the photoelectrode base material,

the cover unit forms the liquid retaining space in a state in which the cover body is disposed on a surface of the photoelectrode base material mounted on the base body, and

the liquid retaining space is a sealed space.

[2-17] The dye adsorption device according to [2-16],

in which the cover unit has a supply hole portion through which the dye solution or the rinse liquid is supplied to the liquid retaining space, and

a recovery hole portion through which the dye solution or rinse liquid that is supplied to the liquid retaining space is recovered.

[2-18] The dye adsorption device according to [2-16],

in which the cover unit has a supply hole portion through which the dye solution or the rinse liquid is supplied to the liquid retaining space, and

the base body has a recovery groove portion or a recovery hole portion through which a dye solution or a rinse liquid which is supplied to the liquid retaining space is recovered.

[2-19] The dye adsorption device according to any one of [2-1] to [2-18], further including:

a pinching portion which presses a surface of the photoelectrode base material by the cover body and pinches the photoelectrode base material between the cover body and the base,

in which the pinching portion is at least one kind of mechanism selected from a vacuum chuck mechanism, a clamp mechanism, a screw mechanism, a spring mechanism, and a magnet mechanism.

[2-20] A liquid retaining jig, including:

a base body on which a photoelectrode base material for a photoelectric conversion element is mounted; and

a cover body which is disposed on a surface of the photoelectrode base material mounted on the base body and forms a liquid retaining space on a surface of a dye adsorption region of the photoelectrode base material,

wherein the cover body includes an elastic member that presses a peripheral portion of the dye adsorption region of the photoelectrode base material mounted on the base body.

[2-21] A method for manufacturing a photoelectric conversion element, the method including:

mounting a photoelectrode base material for a photoelectric conversion element on a base body;

disposing a cover body, which presses a peripheral portion of a dye adsorption region of the photoelectrode base material, on a surface of the photoelectrode base material to form a liquid retaining space; and

supplying a dye solution to the liquid retaining space to adsorb dye to the photoelectrode base material.

### REFERENCE SIGNS LIST

1, 2 Transparent conductive base material
3 Porous semiconductor layer
4 Electrolyte layer
5 Counter electrode
6 Sealing material
11, 21 Base material
12, 22 Transparent conductive layer
41 Structure
41a Inner structure
41b Outer structure
41c Opaque structure
43 Current collector
45 Protective layer
61 Base body
62 Packing
63 Pressing plate
64 Base plate

1. A photoelectric conversion device, comprising:
a conductive base material;
a porous semiconductor layer which is disposed on the conductive base material and onto which dye is adsorbed;
a counter electrode;
an electrolyte layer;
a sealing material that is formed at the periphery of the conductive base material; and
at least one protrusion formed between the porous semiconductor layer and an outer periphery of the sealing material.

2. The photoelectric conversion device according to claim 1,
wherein the protrusion is provided to surround the porous semiconductor layer.

3. The photoelectric conversion device according to claim 1, further comprising:
a plurality of current collector portions provided on the conductive base material,
wherein the protrusion has a plurality of structures that are provided between the plurality of current collector portions.

4. The photoelectric conversion device according to claim 3,
wherein the structure has the same height or substantially the same height as a height of the current collector portions.

5. The photoelectric conversion device according to claim 3,
wherein a difference in the height between the structure and the current collector portions is 100 μm or less.

6. The photoelectric conversion device according to claim 3,
wherein the structure is a structure that suppresses leakage of a dye solution by close contact of an elastic body.

7. The photoelectric conversion device according to claim 3,
wherein a current collector terminal that is connected to the current collector portions is provided at the peripheral portion, and
the sealing material is provided between the current collector terminal and the porous semiconductor layer.

8. The photoelectric conversion device according to claim 3,
wherein each of the current collector portions includes a current collector layer and a protective layer that covers the current collector layer.

9. The photoelectric conversion device according to claim 8,
wherein the structure has one or more layers, and
the layers are formed of at least any material of the current collector layer, the porous semiconductor layer, and the protective layer.

10. The photoelectric conversion device according to claim 1,
wherein the protrusion has a flat surface or a substantially flat surface at a top portion.

11. The photoelectric conversion device according to claim 1,
wherein an opaque structure containing an opaque material as a main component is provided at an external side of the protrusion.

12. The photoelectric conversion device according to claim 11,
wherein the opaque material is a material that is colored with dye.

13. A method for manufacturing a photoelectric conversion device, the method comprising:
forming a porous semiconductor layer on a conductive base material;
forming at least one protrusion between an outer periphery of a sealing material formed at the periphery of the conductive base material, and the porous semiconductor layer; and
bringing an elastic body into close contact with the protrusion to form a liquid retaining space that surrounds the porous semiconductor layer, retaining a dye solution in the liquid retaining space, and adsorbing dye to the porous semiconductor layer.

14. A dye adsorption device, comprising:
a dye solution supply unit; and
a dye solution adsorption unit,
wherein the dye solution adsorption unit includes a liquid retaining jig having a base body on which a photoelectrode base material for a photoelectric conversion element is mounted, and a cover body that forms a liquid retaining space on a surface of the photoelectrode base material, and
the cover body has an elastic member that presses a peripheral portion of a dye adsorption region of the photoelectrode base material mounted on the base body.

15. The dye adsorption device according to claim 14, further comprising:
a dye solution recovery unit that recovers a dye solution collected in the liquid retaining space.

16. The dye adsorption device according to claim 15, further comprising:
a dye solution adjusting unit that adjusts the dye solution recovered by the dye solution recovery unit and supplies the adjusted dye solution to the dye solution supply unit.

17. The dye adsorption device according to claim 14, further comprising:
a rinse liquid supply unit that supplies a rinse liquid to the liquid retaining space; and
a rinse liquid recovery unit that recovers the rinse liquid collected in the liquid retaining space,
wherein the rinse liquid supply unit and the rinse liquid recovery unit carry out a rinse treatment process from supply of the rinse liquid to recovery of the rinse liquid n (n: natural number) or more times with respect to the same photoelectrode base material.

18. The dye adsorption device according to claim 14,
wherein the peripheral portion includes a region for forming a sealing portion of the photoelectrode base material, and
the elastic member covers at least a part of the region for forming the sealing portion of the photoelectrode base material mounted on the base body, and a region between the dye adsorption region and the region for forming the sealing portion.

19. A liquid retaining jig, comprising:
a base body on which a photoelectrode base material for a photoelectric conversion element is mounted; and
a cover body which is disposed on a surface of the photoelectrode base material mounted on the base body and forms a liquid retaining space on a surface of a dye adsorption region of the photoelectrode base material,
wherein the cover body includes an elastic member that presses a peripheral portion of the dye adsorption region of the photoelectrode base material mounted on the base body.

20. A method for manufacturing a photoelectric conversion element, the method comprising:
mounting a photoelectrode base material for a photoelectric conversion element on a base body;
disposing a cover body, which presses a peripheral portion of a dye adsorption region of the photoelectrode base material, on a surface of the photoelectrode base material to form a liquid retaining space; and
supplying a dye solution to the liquid retaining space to adsorb dye to the photoelectrode base material.
